(19) United States
(12) Patent Application Publication
(10) Pub. No.: US 2015/0214752 A1
(43) Pub. Date: Jul. 30, 2015

(54) WIRELESS POWER OUTLET

(71) Applicant: POWERMAT TECHNOLOGIES, LTD., NEVE ILAN (IL)

(72) Inventors: Ilya GLUZMAN, Holon (IL); Arik ROFE, Bet Hakerem (IL); Elieser MACH, Rosh Zurim (IL)

(21) Appl. No.: 14/682,741

(22) Filed: Apr. 9, 2015

Related U.S. Application Data
(63) Continuation-in-part of application No. 14/024,051, filed on Sep. 11, 2013.
Application No. 14/024,051 is a continuation of application No. 12/524,987, filed on Mar. 10, 2010, now Pat. No. 8,629,577.
(60) Provisional application No. 61/006,488, filed on Jan. 16, 2008.
(60) Provisional application No. 60/935,694, filed on Aug. 27, 2007.
(60) Provisional application No. 60/897,868, filed on Jan. 29, 2007.
(60) Provisional application No. 61/977,650, filed on Apr. 10, 2014.

(51) Int. Cl. H02J 5/00

(52) U.S. Cl. CPC H02J 5/005

(57) ABSTRACT

A wireless power outlet configured to transmit power to a wireless power receiver is provided. The wireless power outlet comprises a metal shielding comprising a substantially circular base and a core protruding therefrom, a primary inductive coil constituted by two substantially circular windings one atop the other and giving rise to an internal space, the core being received within the space, and a power source comprising a driver configured to provide an oscillating driving voltage to the primary inductive coil. The base has a diameter which is at least about 10% larger than an outer diameter of the windings, the circular windings comprise a wire having between 165 and 175 thin wire strands, and the space formed within the winding has a diameter between 20 and 21 mm.

### CROSS-REFERENCE TO RELATED APPLICATIONS

This application is a continuation-in-part of U.S. application Ser. No. 14/024,051 filed Sep. 11, 2013 which is a continuation of U.S. application Ser. No. 12/524,987 filed Mar. 10, 2010, which is a National Phase application of PCT/IL2008/00124 claiming priority from U.S. Provisional application Ser. No. 61/006,488 filed on Jan. 16, 2008, U.S. Provisional application Ser. No. 60/935,694 filed on Aug. 27, 2007, and U.S. Provisional application Ser. No. 60/897,868 filed on Jan. 29, 2007. This application also claims the benefit of U.S. Provisional application Ser. No. 61/977,650 filed on Apr. 10, 2014. The contents and disclosure of all of the above documents are incorporated herein by reference in their entirety.

### FIELD OF THE INVENTION

The present disclosure relates to wireless power outlets, and to methods of transferring power thereby.

### BACKGROUND OF THE INVENTION

Electrical connections are commonly facilitated by the use of plugs and jacks. Power jacks are fixed connectors which are stationary relative to the surface into which they are embedded. Power plugs are movable connectors which are adapted to electrically couple with power jacks. The plug-jack coupling allows a movable device hardwired to the plug to be selectively connected to a power jack and disconnected and removed when required. In such electrical couplings it is common for the plug and jack to be mechanically coupled together and conductively connected using a pin and socket combination. The pin and socket coupling provides a way to align the plug to the jack efficiently and to prevent the two from becoming disconnected while in use and the pin, typically copper or brass, forms a conducting contact with a conductive element lining the socket. Where power is being transmitted, such as in a mains power point, where there is a danger of injury from electrocution, it is common that the pin is provided on the plug so that the live power lines may be safely shielded within the sockets of the power jack. Nevertheless, since the live power lines are not fully insulated there is a risk of injury associated with mains sockets, particularly to children who may be tempted to push small fingers or other objects into a live socket. It is therefore common to provide additional protection such as through the use of socket guards and the like.

Moreover, a socket if not maintained, collects dust which may impede electrical connection or even clog the socket, making insertion of the pin difficult. For this reason, power sockets are typically mounted upon walls and are not angled upwards. This configuration also reduces the risk of shorting or electrocution as a result of liquid spillages.

Inductive power connectors for providing insulated electrical connection are known. For example U.S. Pat. No. 7,210,940 to Baily et al. describes an inductive coupling for transferring electrical energy to or from a transducer and measuring circuit. Baily's system consists of a male connector having a single layer solenoid wound on a ferromagnetic rod and a female connector having a second single layer solenoid. By inserting the male connector into the female connector, the two solenoids are brought into alignment, enabling inductive energy transfer therebetween. This coupling provides a sealed signal connection without the disadvantages of having exposed contact surfaces.

In Baily's system the female connector still represents a socket and the male connector a pin. Although there are no exposed contact surfaces, such electrical power jacks cannot be located upon surfaces which need to be flat such as table tops, counters and the like. Because such surfaces are often precisely where electrical connection would be most convenient, this results in unsightly and inconvenient, extensive power connecting cables.

Other electrical power transmission systems allowing a power receiving electrical device to be placed anywhere upon an extended base unit covering a larger area have been proposed. These provide freedom of movement without requiring the trailing wires inherent in Baily. One such example is described in U.S. Pat. No. 7,164,255 to Hui. In Hui's system a planar inductive battery charging system is designed to enable electronic devices to be recharged. The system includes a planar charging module having a charging surface on which a device to be recharged is placed. Within the charging module, and parallel to the charging surface, is at least one, and preferably an array of primary windings that couple energy inductively to a secondary winding formed in the device to be recharged. Hui's system also provides secondary modules that allow the system to be used with conventional electronic devices not supplied with secondary windings.

Such systems are adequate for charging batteries, in that they typically provide a relatively low power inductive coupling. It will be appreciated however, that extended base units such as Hui's charging surface which allows energy transfer approximately uniformly over the whole area of the unit, are not generally suitable for providing the high energy requirements of many electric devices.

U.S. Pat. No. 6,803,744, to Sabo, titled “Alignment independent and self aligning inductive power transfer system” describes an inductive power transfer device for recharging cordless appliances. It also addresses the problem of pinlessly aligning a secondary inductive coil to a primary inductive coil. Sabo's device includes a plurality of inductors arranged in an array and connected to a power supply via switches which are selectively operable to activate the respective inductors. The inductors serve as the primary coil of a transformer. The secondary coil of the transformer is arranged within the appliance. When the appliance is positioned proximate to the power transfer device with the respective coils in alignment, power is inductively transferred from the device to the appliance via the transformer.

Nevertheless the need remains for a cost effective and efficient pinless power coupling mechanism and the present invention addresses this need.

The use of a wireless non-contact system for the purposes of automatic identification or tracking of items is an increasingly important and popular functionality.

Inductive power coupling allows energy to be transferred from a power supply to an electric load without a wired connection therebetween. An oscillating electric potential is applied across a primary inductor. This sets up an oscillating magnetic field in the vicinity of the primary inductor. The oscillating magnetic field may induce a secondary oscillating electrical potential in a secondary inductor placed close to the primary inductor. In this way, electrical energy may be transmitted from the primary inductor to the secondary inductor by electromagnetic induction without a conductive connection between the inductors.

When electrical energy is transferred from a primary inductor to a secondary inductor, the inductors are said to be inductively coupled. An electric load wired in series with such a secondary inductor may draw energy from the power source wired to the primary inductor when the secondary inductor is inductively coupled thereto.

### SUMMARY OF THE INVENTION

According to one aspect of the presently disclosed subject matter, there is provided a wireless power outlet configured to transmit power to a wireless power receiver, the wireless power outlet comprising: a metal shielding comprising a substantially circular base and a core protruding therefrom; a primary inductive coil constituted by two substantially circular windings one atop the other and giving rise to an internal space, the core being received within the space; and a power source comprising a driver configured to provide an oscillating driving voltage to the primary inductive coil; wherein: the base has a diameter which is at least about 10% larger than an outer diameter of the windings; the circular windings comprise a wire having between 165 and 175 thin wire strands; and the space has a diameter between 20 and 21 mm.

The wire may be litz wire. The wire may consist of 170 strands. The diameter of each of the strands may be provided such that it is no more than twice the skin depth of the conductive material of the wire, at an operating AC current and frequency of the wireless power outlet. Each of the windings may be formed having nine turns. The shielding may be made from a material selected from magnesium ferrite and nickel. The core may be substantially circular and configured to be snuggly received within the space formed within the winding. The core may be substantially circular and have a diameter of about 20 mm. The base may have a thickness of about 2.75 mm. The shielding may have a thickness of about 6 mm. The wireless power outlet may have a quality-factor of at least about 140. The wireless power outlet may be configured to operate in a range between about 100 kHZ and about 500 kHz. The wireless power outlet may further comprise a controller configured to direct operation thereof.

### BRIEF DESCRIPTION OF THE DRAWINGS

For a better understanding of the embodiments and to show how it may be carried into effect, reference will now be made, purely by way of example, to the accompanying drawings.

With specific reference now to the drawings in detail, it is stressed that the particulars shown are by way of example and for purposes of illustrative discussion of the preferred embodiments of the present invention only, and are presented in the cause of providing what is believed to be the most useful and readily understood description of the principles and conceptual aspects of the invention. In this regard, no attempt is made to show structural details of the invention in more detail than is necessary for a fundamental understanding of the invention; the description taken with the drawings making apparent to those skilled in the art how the several forms of the invention may be embodied in practice. In the accompanying drawings:

FIG. 1 is a block diagram schematically representing the main features of an inductive power transfer system according to one embodiment of the present invention;

FIG. 2a is a schematic representation of a pinless power coupling consisting of a pinless power jack and a pinless power plug according to another embodiment of the present invention;

FIG. 2b-d show three exemplary applications of the power coupling of FIG. 2a providing power to a computer, light bulb and pinless power adaptor;

FIGS. 3a and 3b show an exemplary configuration for an induction coil in schematic and exploded representation respectively;

FIGS. 4a-c show three exemplary tactile alignment mechanisms for aligning a pinless power plug to a pinless power jack according to further embodiments of the invention;

FIGS. 5a-h show eight magnetic configurations for use in a tactile alignment mechanism for a pinless power coupling;

FIGS. 6a-e show three exemplary plug-mounted visual alignment mechanisms for a pinless power coupling;

FIGS. 7a-d show four exemplary surface-mounted visual alignment mechanisms for a pinless power coupling;

FIGS. 8a and 8b show audible alignment means for use with the pinless power coupling according to still further embodiments of the invention;

FIG. 9 shows an exemplary optical transmitter for regulating power transfer to a computer via a pinless power coupling;

FIG. 10 is a block diagram illustrating the main features of an exemplary signal transfer system for initiating and regulating inductive power transfer from the pinless power plug;

FIG. 11a shows a power surface including an array of pinless power jacks in accordance with yet another embodiment of the invention;

FIG. 11b shows two movable pinless power plugs lying upon the power surface of FIG. 11a;

FIG. 11c shows a power plug provided with two secondary coils for coupling with primary coils of the power surface of FIG. 11a;

FIGS. 12a-c show three exemplary applications of the power surface of FIG. 11a providing power to a computer, light bulbs and pinless power adaptors respectively;

FIG. 13 is a flow diagram flowchart showing a method for transferring an optical regulation signal between a primary unit and a secondary unit via an intermediate layer;

FIG. 14 is a schematic illustration of a wireless power outlet according to the presently disclosed subject matter;

FIG. 15 is a top view of a primary inductive coil of the wireless power outlet illustrated in FIG. 14; and

FIGS. 16A and 16B are top and side views, respectively, of a shielding of the wireless power outlet illustrated in FIG. 14.

### DETAILED DESCRIPTION

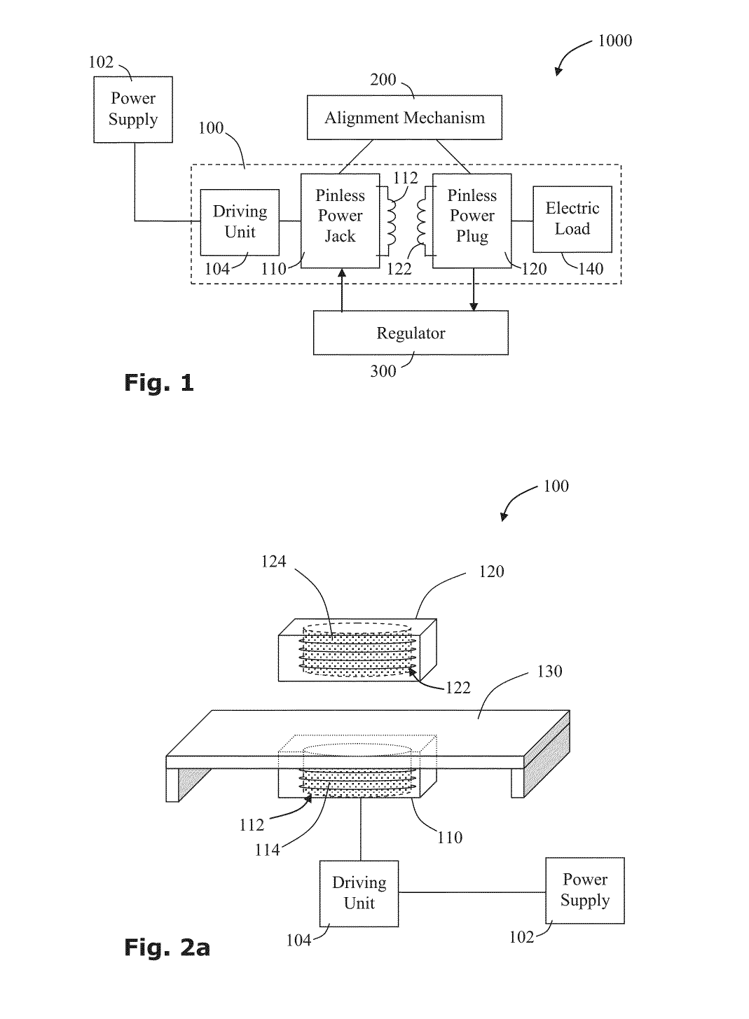

Reference is now made to FIG. 1 which is a 1000 for pinlessly providing power to an electric load 140, according to a first embodiment of the invention. The power transfer system 1000 includes a pinless power coupling 100, an alignment mechanism 200 and a power regulator 300.

The pinless power coupling 100 comprises a pinless power jack 110 and a pinless power plug 120. The pinless power jack 110 includes a primary inductive coil 112 wired to a power supply 102 via a driving unit 104. The pinless power plug 120 includes a secondary inductive coil 122 which is wired to the electric load 140. When the secondary coil 122 is brought close to the primary coil 112 and a variable voltage is applied to the primary coil 112 by the driving unit 104, power may be transferred between the coils by electromagnetic induction.

The alignment mechanism 200 is provided to facilitate aligning the primary coil 112 with the secondary coil 122 which improves the efficiency of the inductive coupling. The regulator 300 provides a communication channel between the pinless power plug 120 and the pinless power jack 110 which may be used to regulate the power transfer.

The various elements of the pinless power transfer system 1000 may vary significantly between embodiments of the present invention. A selection of exemplary embodiments are described herebelow in a non-limiting manner.

### Pinless Power Coupling

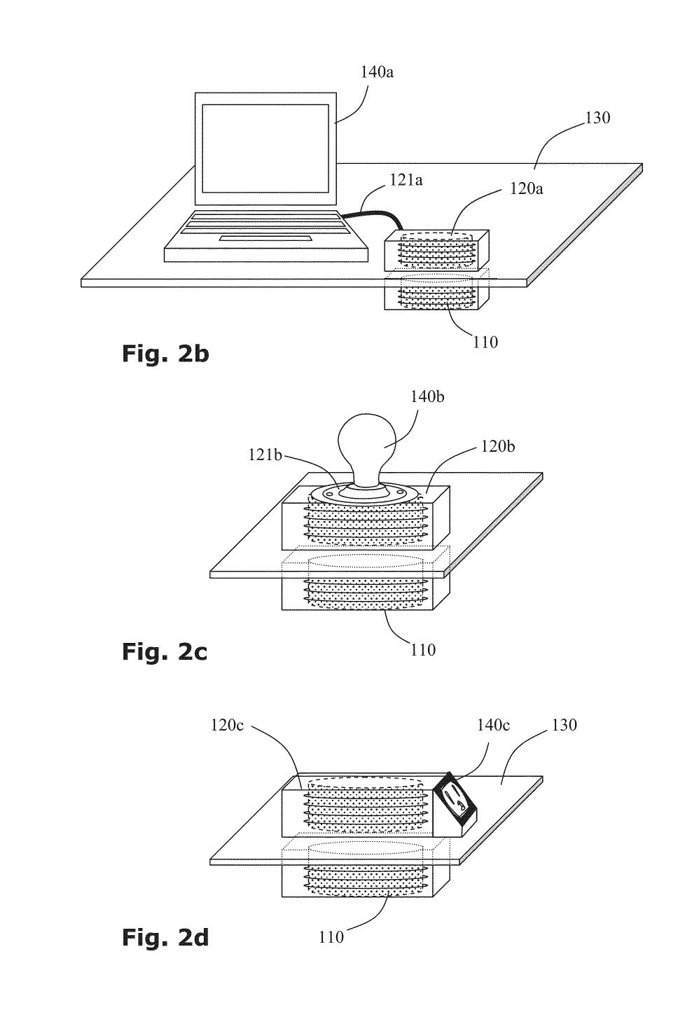

Reference is now made to FIG. 2a which shows a pinless power coupling 100 according to a second embodiment of the invention. A pinless power jack 110, which may be incorporated into a substantially flat surface 130 for example, is couplable with a pinless power plug 120. The pinless power jack 110 includes an annular primary coil 112 shielded behind an insulating layer, which may be hardwired to a power source 102 via a driving unit 104. Driving electronics may include a switching unit providing a high frequency oscillating voltage supply, for example.

The pinless power plug 120 includes an annular secondary coil 122 that is configured to inductively couple with the primary coil 112 of the pinless power jack 110 to form a power transferring couple that is essentially a transformer. Optionally, a primary ferromagnetic core 114 is provided in the pinless power jack 110 and a secondary ferromagnetic core 124 is provided in the pinless power plug 120 to improve energy transfer efficiency.

It will be appreciated that known pinned power couplings of the prior art cannot be readily incorporated into flat surfaces. The nature of any pinned coupling is that it requires a socket into which a pin may be inserted so as to ensure power coupling. In contradistinction, the pinless power coupling 100 of the second embodiment of the invention has no pin or socket and may, therefore, be incorporated behind the outer face of a flat surface 130, such as a wall, floor, ceiling, desktop, workbench, kitchen work surface, shelf, door or the like, at a location where it may be convenient to provide power.

It is specifically noted that because the primary coil 112 of the second embodiment is annular in configuration, alignment of the primary coil 112 to the secondary coil 122 is independent of the angular orientation of the pinless power plug 120. This allows the pinless power plug 120 to be coupled to the pinless power jack 110 at any convenient angle to suit the needs of the user and indeed to be rotated whilst in use.

For example, a visual display unit (VDU) may draw its power via a pinless power plug 120 of the second embodiment aligned to a pinless power jack 110 of the second embodiment incorporated into a work desk. Because of the annular configuration of the coils 112, 122, the angle of the VDU may be adjusted without the pinless coupling 100 being broken.

Prior art inductive coupling systems are not easily rotatable. For example, in order to achieve partial rotation, the system described in U.S. Pat. No. 6,803,744, to Sabo, requires the coils to be connected by flexible wires or brushes to concentric commutators on the body of a non-conductive annular container. Even so, Sabo's system allows rotation of only about half the intercoil angle. In contradistinction, the pinless power plug 120 of the second embodiment of the present invention may be rotated through 360 degrees or more, about the central axis of the annular primary coil 110 whilst continually maintaining the power coupling 100.

It is known that inductive energy transfer is improved considerably by the introduction of a ferromagnetic core 114, 124. By optimization of the coupling 100, appropriate electrical loads, such as standard lamps, computers, kitchen appliances and the like may draw power in the range of 10 W-200 W for example.

Three exemplary applications of the pinless power jack 110 of FIG. 2a, are illustrated in FIGS. 2b-d, according to various embodiments of the present invention. With reference to FIG. 2b, a computer 140a is shown connected by a power cord 121a to a first pinless power plug 120a. The pinless power plug 120a is inductively coupled to a pinless power jack 110 embedded in a desk top 130. The pinless power plug 120a may thereby draw power from the pinless power jack 110 to power the computer 140a, to charge its onboard power cells or both. The parameters such as charging voltage and current for power provision to computers depends upon the model of the computer and therefore the pinless power plug 120a may be adapted to provide a range of voltages, typically between 5-20V and may transfer power at up to 200 W. Alternatively or additionally, a variety of pinless power jacks and/or pinless power plugs may be provided which transfer various power levels for various appliances.

With reference to FIG. 2c, a light bulb 140b connected to a light socket 121b integral to a second pinless power plug 120b is shown. The pinless power plug 120b may be inductively coupled to a pinless power jack 110 by being aligned therewith, and supplies power directly to the light bulb 140b. It is noted that the voltage and power to be provided by the power plug 120b depends upon the rating of the specific light bulb 140b. The power jack 110 may be configured to provide an appropriate power level and voltage such as 1-12V for flash-light type bulbs or 110V for mains bulbs in North America or 220V for mains bulbs in Europe. Alternatively the secondary coil in the plug 120b may both transmit and step down the voltage.

Referring now to FIG. 2d, a pinless power plug adaptor 120c is shown having a conventional power socket 140c thereupon, into which an electrical load (not shown) may be plugged using a conventional power cable (not shown) with a conventional pinned plug thereupon. The pinless plug adaptor 120c is shown coupled to a power jack 110 embedded into a flat surface 130. It is noted that a pinless power plug adaptor 120c may be coupled with a pinless jack 110 thereby allowing electrical power to be supplied to conventional electrical devices having pinned plugs. The pinless power plug adaptor 120c is typically configured to provide a mains voltage signal of 110V AC in North America or 220V AC in Europe although other voltages, including DC voltages via an internal rectifier may be provided where required.

The induction coils 112, 122 for use in the pinless power coupling 100 may be made of coiled wires or they may be manufactured by a variety of techniques such as screen printing, or etching for example.

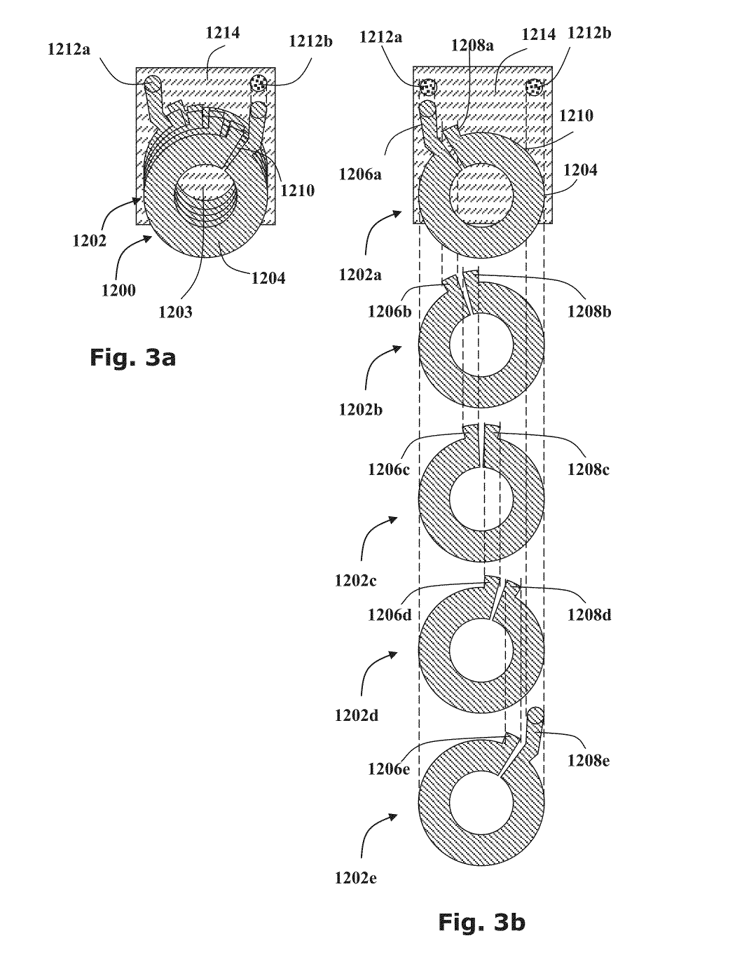

FIGS. 3a and 3b schematically represent an exemplary induction coil 1200, according to a third embodiment of the invention in schematic and exploded views respectively. The induction coil 1200 is annular in form and is suitable for use as a primary coil 112 in a pinless power jack 110 or for use as a secondary coil 122 in a pinless power plug 120. The coil is noted to provide a particularly good coupling for its overall size. An induction coil 1200 is formed by stacking a plurality of conducting rings 1202a-e upon a base board 1214. The induction coil 1200 is in contact with two point contacts 1212a, 1212b upon the base board 1214. Each conducting ring 1202 has a leading protruding contact 1208 and a trailing protruding contact 1206 which protrude radially from the center of a split ring 1204 and are located on either side of insulating gap 1210.

The conducting rings 1202a-e are stacked in such a manner that each ring is insulated from the rings adjacent to it. The insulating gaps 1210 in the conducting rings 1202 are configured such that the leading protruding contact 1208a of a first ring 1202a makes contact with the trailing protruding contact 1206b of a second ring 1202b. In turn the leading protruding contact 1208b of the second ring 1202b makes contact with the trailing protruding contact 1206c of a third ring 1402c and so forth until all the rings 1202a-e stack together to form an induction coil 1200. The leading protruding contact of the final ring 1208e and the trailing protruding contact of the first ring 1206a are extended to form electrical contact with contact points 1212a, 1212b upon the base board 1214. It will be appreciated that this configuration produces an annular induction coil 1200 with a free central axis 1203 which may accommodate inter alia a ferrite core, a magnetic alignment mechanism (see below) and/or an optical signal transfer system (see below).

The individual rings 1202a-e may be manufactured by a variety of techniques such as by circuit sandwiching, circuit printing, fabrication printing, circuit etching, stamping and the like. Although the induction coil 1200 of the third embodiment shown in FIGS. 3a and 3b consists of a mere five rings 1202a-e, it will be appreciated that the number of rings that may be stacked to form induction coils in this manner may vary considerably, as may their dimensions. Thus induction coils with the desired properties may be formed.

### Alignment Mechanisms

The efficiency of the power coupling 100, depends upon the alignment between the secondary coil 122 of the pinless power plug 120 and the primary coil 112 of the pinless power jack 110. Where the substantially flat surface 130 is fabricated from transparent material such as glass or an amorphous plastic, such as PMMA for example, the user is able to see the pinless power plug 110 directly and may thus align the pinless plug 120 to the pinless jack 110 by direct visual observation. However, where the substantially flat surface 130 is opaque alternative alignment mechanisms 200 may be necessary. Such alignment mechanisms 200 may include tactile, visual and/or audible indications, for example.

### Tactile Alignment Mechanisms

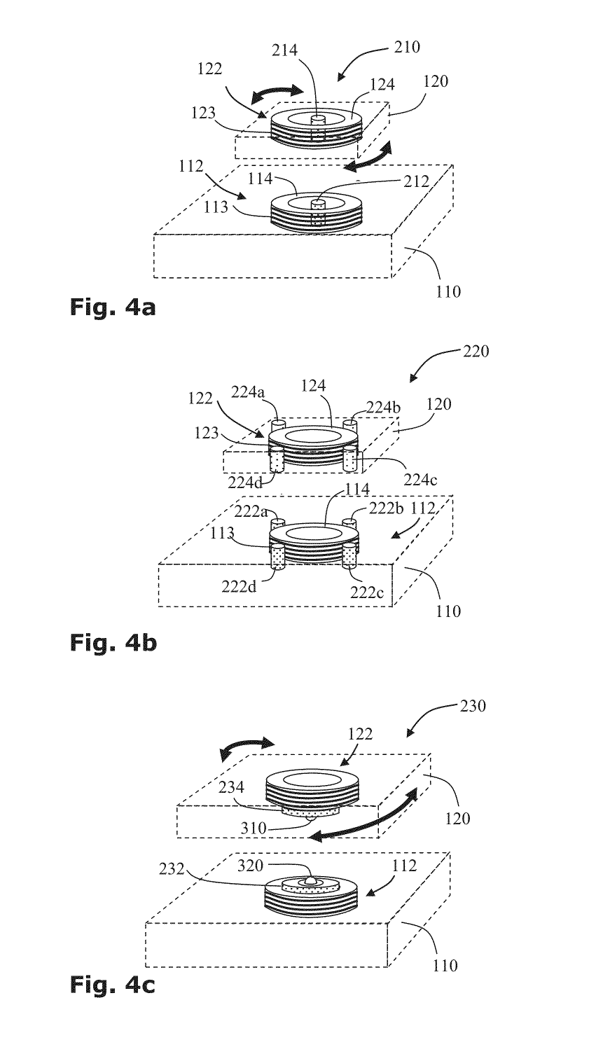

With reference now to FIGS. 4a-c, three exemplary tactile alignment mechanisms 210, 220, 230 are shown according to various embodiments of the invention. Referring particularly to FIG. 4a, a first tactile alignment mechanism 210 is shown wherein the pinless power jack 110 includes a central magnetic snag 212 surrounded by an annular primary coil 112 and the corresponding pinless power plug 120 includes a central magnetic anchor 214 surrounded by an annular secondary coil 122.

The primary coil 112 of this embodiment consists of a primary conducting wire 113, preferably a litz wire which is wound around a primary ferromagnetic core 114 and the secondary coil 122 consists of a secondary conducting wire 123, again preferably a litz wire which is wound around a secondary ferromagnetic core 124. When aligned, the primary ferromagnetic core 114 and the secondary ferromagnetic core 124 form a magnetic couple that increases the magnetic flux linkage between the primary coil 112 and the secondary coil 122, allowing electrical energy to be transmitted more efficiently therebetween.

The central magnetic snag 212 is configured to engage with the magnetic anchor 214 carried by the pinless power plug 120, when the secondary coil 122 is optimally aligned to the primary coil 112 of the pinless power jack 110. It will be appreciated that the attraction between the magnetic anchor 214 and the magnetic snag 212 may be felt by an operator, thereby providing a tactile indication of alignment. In addition, the anchor-snag arrangement, once engaged, also serves to lock the pinless power plug 120 into alignment with the pinless power jack 110. The combination of a central circular magnetic snag 212 and a concentric annular primary coil 112, allows the plug 120, having a central magnetic anchor 214, to rotate around a central axis without losing alignment and thus to be aligned at any orientation.

A second tactile alignment mechanism 220 is shown in FIG. 4b wherein pinless power jack 110 includes four magnetic corner snags 222a-d which are arranged at four points around primary coil 112, being a primary conducting wire 113 wound around a primary ferromagnetic core 114. The four magnetic corner snags 222a-d are configured to magnetically couple with four magnetic corner anchors 224a-d carried by a pinless power plug 120, when the primary coil 112 and secondary coil 122 are aligned.

In embodiments where rotation of the secondary coil 122 may impede energy transfer or is otherwise undesirable, multiple magnetic snags 222 may be used to limit the rotation of the plug 120 about its central axis to four specific alignment angles. At each of the compass points, the secondary ferromagnetic core 124 is orientated and aligned to the primary ferromagnetic core 114. The primary ferromagnetic core 114 and the secondary ferromagnetic core 124 thus provided, form a magnetic couple that increases the magnetic flux linkage between the primary coil 112 and the secondary coil 122, allowing electrical energy to be transmitted more efficiently therebetween. It will be appreciated that the number and configuration of multiple magnetic snags 222 and magnetic anchors 224 may be selected to provide various multiple discrete alignment angles.

With reference to FIG. 4c, a third tactile alignment mechanism 230 is shown, wherein the pinless power jack 110 includes an annular magnetic snag 232 concentric with a primary coil 112. The annular magnetic snag 232 is configured to engage with an annular magnetic anchor 234 concentric with a secondary coil 122 in a pinless plug 120. The annular configuration provides a free central axis which may be used to accommodate an optical transmitter 310 and an optical receiver 320 of an optical signal system for the regulation of power transfer. The third tactile alignment mechanism 230 allows the plug 120 to rotate around its central axis without compromising the alignment between the primary coil 112 and the secondary coil 122, or between the optical transmitter 310 and the optical receiver 320 of the optical signal system. The power plug 120 may thus to be orientated at any angle to suit requirements.

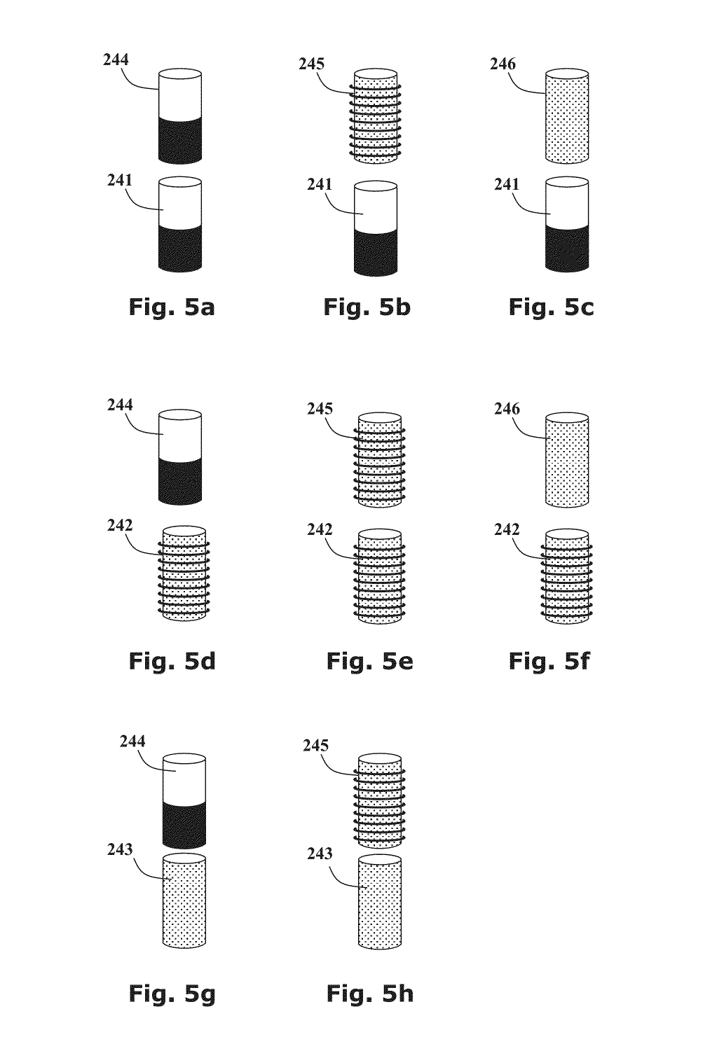

For magnetic coupling, it will be appreciated that a permanent or electro magnet in the jack may exert an attractive force on a second permanent or electromagnet in the plug. Alternatively, the plug may be fitted with a piece of ferrous material that is attracted to a magnet but is not itself, magnetic. Furthermore, the jack may include a piece of iron that is attracted to a magnet, and the plug may be provided with a permanent or electo-magnet. By way of illustration of this, with reference to FIGS. 5a-h, eight alternative magnetic alignment mechanisms for use in coupling a pinless power plug 120 with a pinless power jack 110 are shown. A permanent magnetic snag 241 may couple with any of a permanent magnetic anchor 244, an electromagnetic anchor 245 or a ferromagnetic element 246. An electromagnetic snag 242 may couple with any of a permanent magnetic anchor 244, an electromagnetic anchor 245 or a ferromagnetic element 246. A ferromagnetic snag 243 may couple with a permanent magnetic anchor 244, or an electromagnetic anchor 245.

It is noted that a primary ferromagnetic core 114 of a pinless power jack 110 may itself serve as a ferromagnetic snag 243. Alternatively, the primary coil 112 may serve as an electromagnetic snag 242. It is further noted that a secondary ferromagnetic core 124 of a pinless power plug 120 may serve as a ferromagnetic anchor 246. Alternatively, the secondary coil 122 may serve as an electromagnetic anchor 245.

A preferred magnetic alignment configuration is shown in FIG. 5a illustrating a permanent magnetic snag 241 configured to couple with a permanent magnetic anchor 244. The orientations of the magnetic snag 241 and the magnetic anchor 244 are such that facing ends have opposite polarity so that they are mutually attractive. It is noted that in certain embodiments two distinct types of pinless power jacks 120 are provided for coupling with two distinct types of pinless power plugs, for example, a high power coupling and a low power coupling. In such embodiments it is important to avoid a low power plug being aligned with a high power jack, for example. The magnetic anchors may prevent incorrect coupling by using opposite polarities for each type of coupling. Thus, the low power plug may have North seeking polar magnetic anchor, say, to engage with a South seeking polar magnetic snag on the low power jack and the high power plug may have a South seeking polar magnetic anchor to engage with a North seeking polar magnetic snag on the high power jack. If the low power plug of this embodiment is placed proximate to the high power jack the North seeking polar anchor repels the North seeking polar snag and the couple can not be aligned.

It will be appreciated that, apart from magnetic mechanisms, other anchor-and-snag type tactile alignment means may alternatively be used such as suckers, hook-and-loop arrangements, ridge-and-groove arrangements and the like. Likewise these may be designed to selectively couple with only a selection of different power jacks in a common surface.

### Visual Alignment Mechanisms

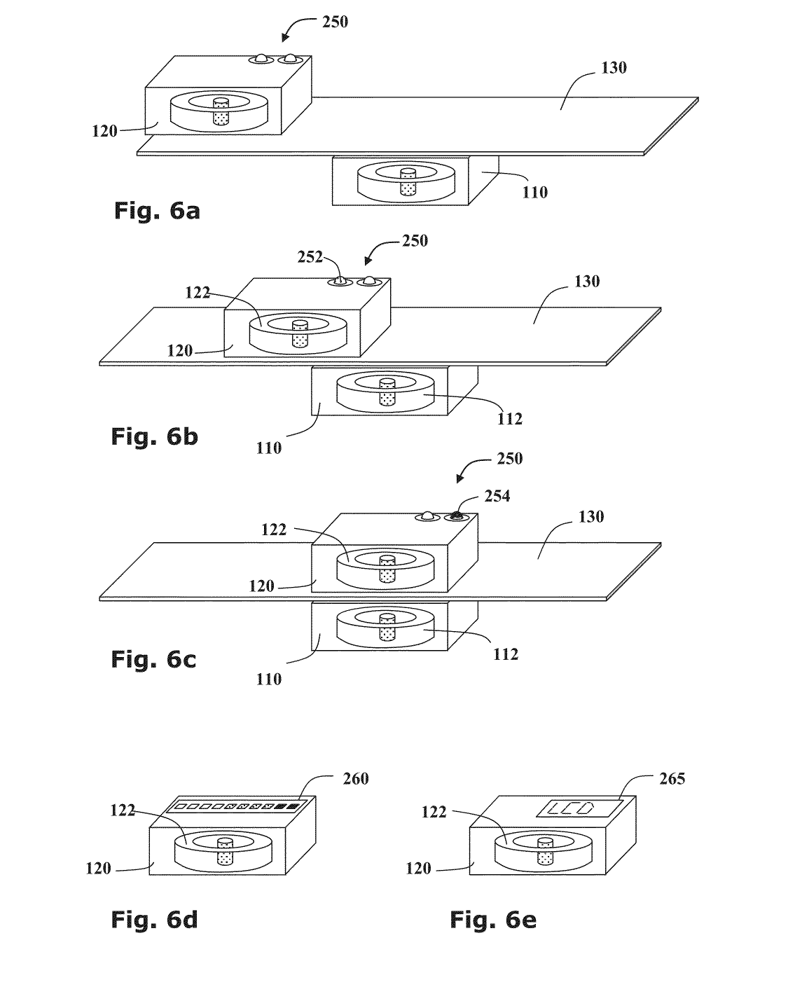

With reference to FIGS. 6a-e exemplary visual alignment mechanisms for a pinless power plug 120 are shown. FIGS. 6a-c show a pinless power plug 120 having a first visual indicator 250 consisting of two indicator LEDs: a rough alignment indicating orange LED 252 and fine alignment indicating green LED 254. A pinless power jack 110 is concealed beneath an opaque surface 130. FIG. 6a shows the pinless power plug 120 at a large distance from the pinless power jack 110 with neither of the two indicator LEDS being activated. FIG. 6b shows the pinless power plug 120 partially aligned with the pinless power jack 110 and the orange indicator LED 252 being lit up. This alerts a user that the plug 120 is in proximity with a pinless power jack 110, but is not properly aligned therewith. Referring to FIG. 6c, when the pinless power plug 120 is optimally aligned with the pinless power jack 110, the green indicator LED 254 is activated to signal to a user that the plug 120 and (concealed) jack 110 are properly aligned and optimal power transfer is possible.

FIG. 6d shows a second visual indicator consisting of a plurality of LEDs in a strip 260; it being appreciated that a larger number of LEDs provides for a greater degree of graduation in indication of proximity, and helps the user home in on the concealed jack. With reference to FIG. 6e, showing a third visual indicator, instead of or in addition to LEDs, an LCD display 265 may provide an alternative visual indicator, which can, in addition to providing indication of the degree of alignment, also provide indication of the current drawn by the load coupled to the plug, for example.

By their nature, LEDs are either illuminated or not illuminated, however proximity data may be encoded by flashing, frequency or the like. The intensity of power supplied to other types of indicator lamps may be used to indicate the degree of coupling, or a flashing indicator lamp may be provided, such that the frequency of flashing is indicative of degree of alignment. Indeed, where the load is an incandescent light source or the like, it may be used directly for alignment purposes, since poor alignment results in a noticeable dimming affect.

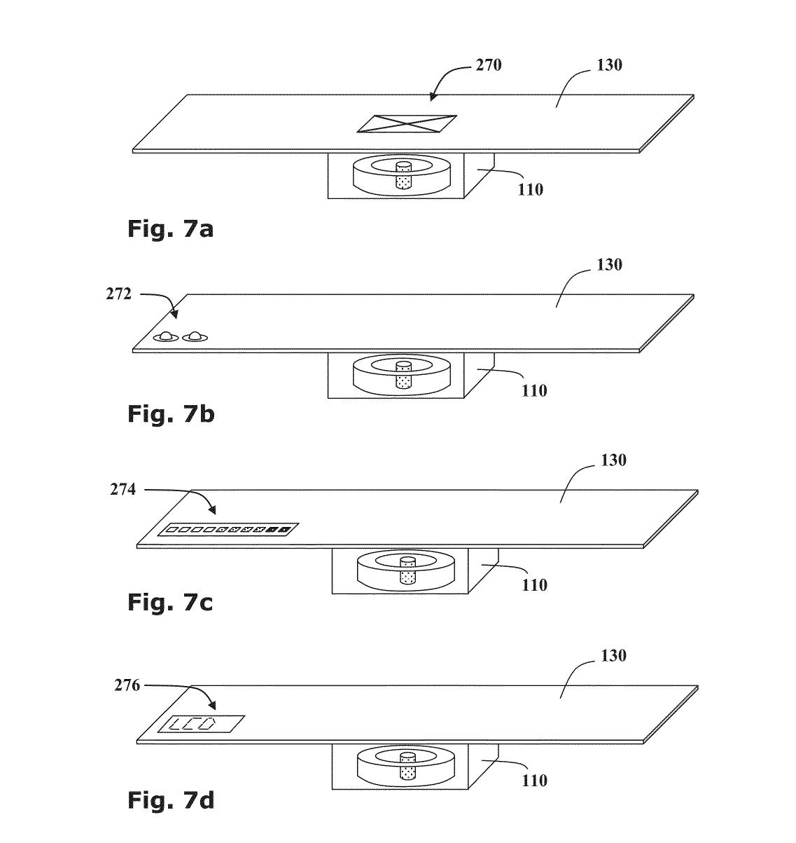

Additionally or alternatively to plug-mounted visual indicators for jack-plug alignment surface-mounted visual indicators may be provided. Thus, with reference to FIGS. 7a-d, various exemplary visual alignment mechanisms are shown located upon a flat surface 130 in which a pinless power jack 110 has been embedded. In FIG. 7a, showing a fourth visual indicator, a mark 270 has been made on the flat surface 130 directly above the concealed pinless power jack 110. This enables the user to physically align the plug with the mark 270 and thus with the concealed jack FIG. 7b shows a fifth visual indicator 272 consisting of two indicator LEDs embedded in the surface 130. This works as per the embodiment of FIGS. 6b and 6c, mutatis mutandis to provide a graduated indication of alignment. Similarly, FIG. 7c shows a sixth visual indicator 274 consisting of a plurality of LEDs in a strip embedded in the surface 130 for a more graduated degree of alignment indication and FIG. 7d shows a seventh visual indicator 276 consisting of an LCD display embedded in the surface 130.

### Audible Alignment Mechanisms

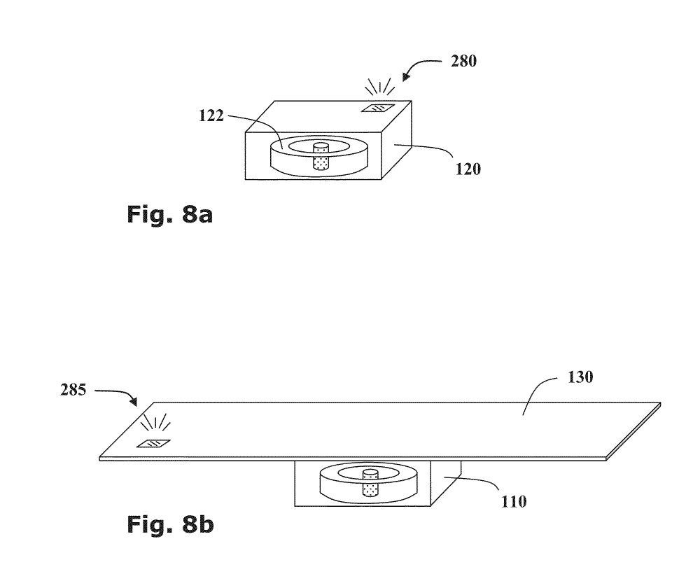

Non-visual alignment means may alternatively or additionally be provided for example, an audible signal may assist the visually impaired attain alignment. As shown in FIG. 8a, a pinless power plug 120 may include a buzzer 280. The buzzer 280 may be configured to provide graduated indication of proximity to alignment for example by variation in tone, pitch, volume, timbre, beep frequency or the like. Alternatively an audible alignment means may be surface-mounted as shown in FIG. 8b, showing a buzzer 285 embedded in the surface 130, configured to buzz in a manner indicating whether there is, and extent of alignment.

### Power Regulation

Efficient power transfer requires regulation. In order to regulate the characteristics of the power provided to the secondary coil 122, such as voltage, current, temperature and the like, feedback from the device to the power jack 110 is desirable. According to further embodiments of the present invention, a power regulator 300 provides a communications channel between the power plug 120 wired to the load and the power jack 110.

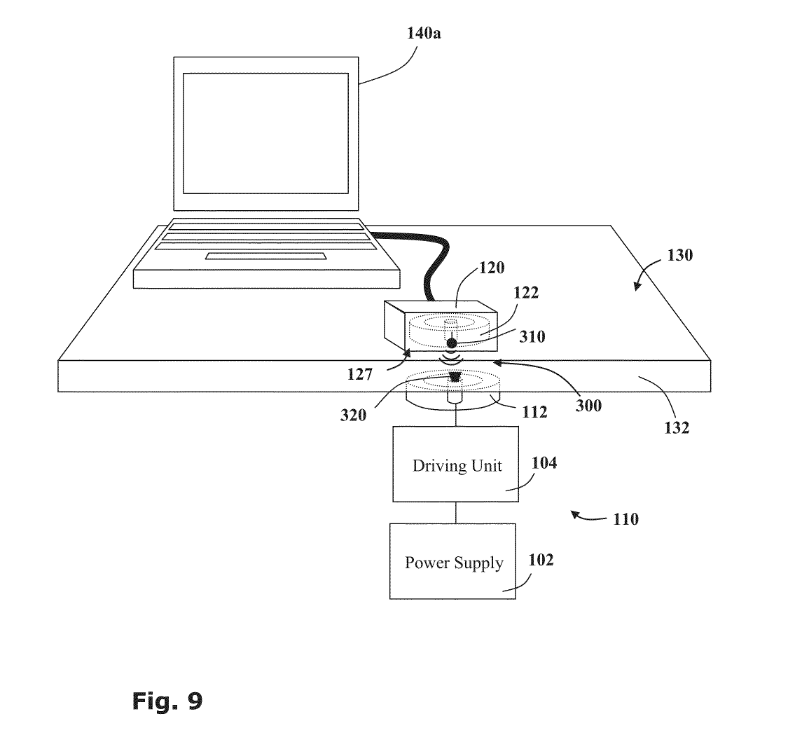

A first exemplary power regulator 300 is illustrated in FIG. 9. An optical transmitter 310, such as a light emitting diode (LED), may be incorporated within the pinless power plug 120 and operably configured to transmit electromagnetic radiation of a type and intensity capable of penetrating both the casing 127 of the pinless power plug 120, and a shielding layer 132 of the substantially flat surface 130. An optical receiver 320, such as a photodiode, a phototransistor, a light dependent resistors or the like, is incorporated within the pinless power jack 110 for receiving the electromagnetic radiation transmitted through the surface layer 132. In preferred embodiments the optical transmitter 310 and the optical receiver 320 are configured along the axis of the annular primary coil 112. This permits alignment to be maintained through 360 degree rotation of the pinless power plug 120.

It is noted that many materials are partially translucent to infra-red light. It has been found that relatively low intensity infra red signals from LEDs and the like, penetrate several hundred microns of common materials such as plastic, cardboard, Formica or paper sheet, to a sufficient degree that an optical receiver 320, such as a photodiode, a phototransistor, a light dependent resistor or the like, behind a sheet of from 0.1 mm to 2 mm of such materials, can receive and process the signal. For example a signal from an Avago HSDL-4420 LED transmitting at 850 nm over 24 degrees, may be detected by an Everlight PD15-22C-TR8 NPN photodiode, from behind a 0.8 mm Formica sheet. For signaling purposes, a high degree of attenuation may be tolerated, and penetration of only a small fraction, say 0.1% of the transmitted signal intensity may be sufficient. Thus an infra-red signal may be used to provide a communication channel between primary and secondary units galvanically isolated from each other by a few hundred microns of common sheet materials such as wood, plastic, Formica, wood veneer, glass etc.

Where the intermediate surface layer is opaque to infra-red, particularly where the intermediate surface layer is relatively thick, an optical path may be provided to guide the signal to the optical receiver 320. Typically, the optical path is a waveguide such as an optical fiber, alternatively, the optical receiver 320 may be placed behind an opening in the face of the surface and covered with a translucent window.

In inductive couples, the communication channel may be used to transfer data between the primary and the secondary coils. The data transferred may be used to regulate the power transfer, for example. Typically the signal carries encoded data pertaining to one or more items of the following list: the presence of the electric load; the required operating voltage for the electric load; the required operating current for the electric load; the required operating temperature for the electric load; the measured operating voltage for the electric load; the measured operating current for the electric load; the measured operating temperature for the electric load, or a user identification code.

Such a signal may be useful in various inductive energy couples usable with the present invention such as transformers, DC-to-DC converters, AC-to-DC converters, AC-to-AC converters, flyback transformers, flyback converters, full-bridge converters, half-bridge converters and forward converters.

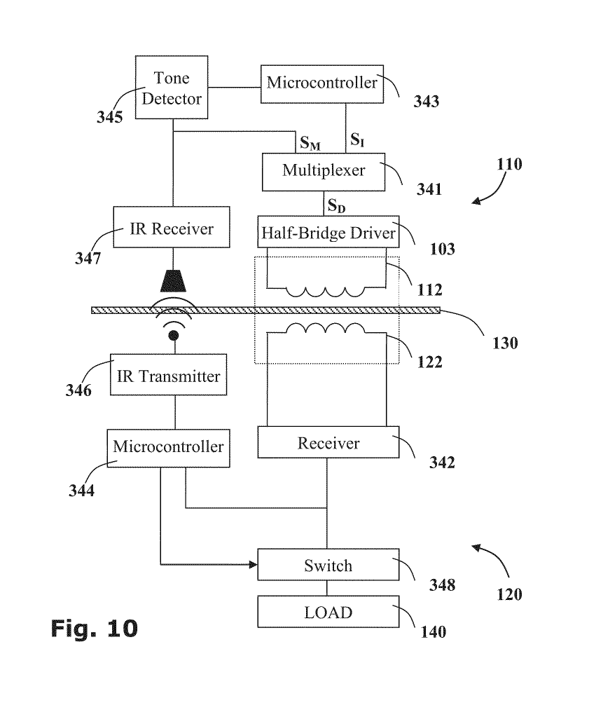

Referring now to FIG. 10, a block diagram is presented illustrating the main features of an exemplary signal transfer system for initiating and regulating inductive power transfer according a second embodiment of the power regulator 300. An inductive power outlet, such as a pinless power jack 110, is configured to couple with a secondary unit, such as a pinless power plug 120, separated therefrom by a surface layer 130. Power is transferred to an electric load 140 wired to the pinless power plug 120.

The pinless power jack 110 includes a primary inductive coil 112, a half-bridge driver 103, a multiplexer 341, a primary microcontroller 343, a tone detector 345 and an optical receiver 347. The secondary unit, such as pinless power plug 120, consists of a secondary coil 122, a receiver 342, a secondary microcontroller 344, an optical transmitter 346 and a load connecting switch 348.

The primary inductive coil 112 of the inductive power outlet is driven by the half-bridge driver 103 which receives a driving signal S_{D} from the multiplexer 341. The multiplexer 341 selects between an initialization signal S_{I} or a modulation signal S_{M}. The initialization signal S_{I} provides a detection means for activating the inductive power outlet 110 when a secondary unit 120 is present. Once active, the modulation signal S_{M} provides a means for regulating power transfer from the power outlet 110 to the secondary unit 120.

Secondary unit detection is provided by the primary microcontroller 343 intermittently sending an initialization signal S_{I} to the multiplexer 341 when the power outlet 110 is inactive. The multiplexer 341 relays the initialization signal S_{I} to the half-bridge driver 103, which results in a low powered detection pulse being transmitted by the primary coil 112. If a secondary unit 120 is aligned with the inductive power outlet 110, the low powered detection pulse is inductively transferred to the secondary coil 122 across the surface layer 130. The receiver 342 is configured to receive this detection pulse and relay a detection signal to the secondary microcontroller 344 which sends a signal to the load connector switch 348 to connect the load and triggers the optical transmitter 346 to transmit an optical signal through the surface layer 130 confirming that the secondary unit 120 is in place. The optical signal is received by the optical receiver 347 in the power outlet 110, and is then relayed to the tone detector 345 which sends a confirmation signal to the primary microcontroller 343. The primary microcontroller 343 then activates the power outlet 110 by triggering the multiplexer 341 to select the modulation signal S_{M} to regulate the power transfer.

The modulation signal S_{M} comes directly from the optical receiver 347 and is used to regulate the duty cycle of the half-bridge driver 103. Power transferred to the secondary unit 120 is monitored by the secondary microcontroller 344. The secondary microcontroller 344 generates a modulation signal S_{M} and sends it to the optical transmitter 346, which transmits a digital optical signal. The modulation signal S_{M} is thus received by the optical detector 347 of the primary unit 110, relayed to the multiplexer 341 and used to regulate the half-bridge driver 103.

Prior art inductive power transfer systems control and regulate power from the primary unit 110. In contradistinction, it is a feature of this second embodiment of the power regulator that the power transfer is initiated and regulated by a digital signal sent from the secondary unit 120. One advantage of this embodiment of the invention is that the regulation signal is determined by the secondary microcontroller 344 within the pinless power plug 120, which is hard wired to the load. Therefore conductive communication channels to the secondary microcontroller 344 may be used to transmit analogue signals to the secondary microcontroller 344 for monitoring the power transfer and a digital signal may be used for communicating between the pinless power plug 120 and the pinless power jack 110.

### Multicoil Systems

Alignment of a pinless power plug to a pinless power jack may be facilitated by using a plurality of induction coil and thereby increasing the number of alignment locations.

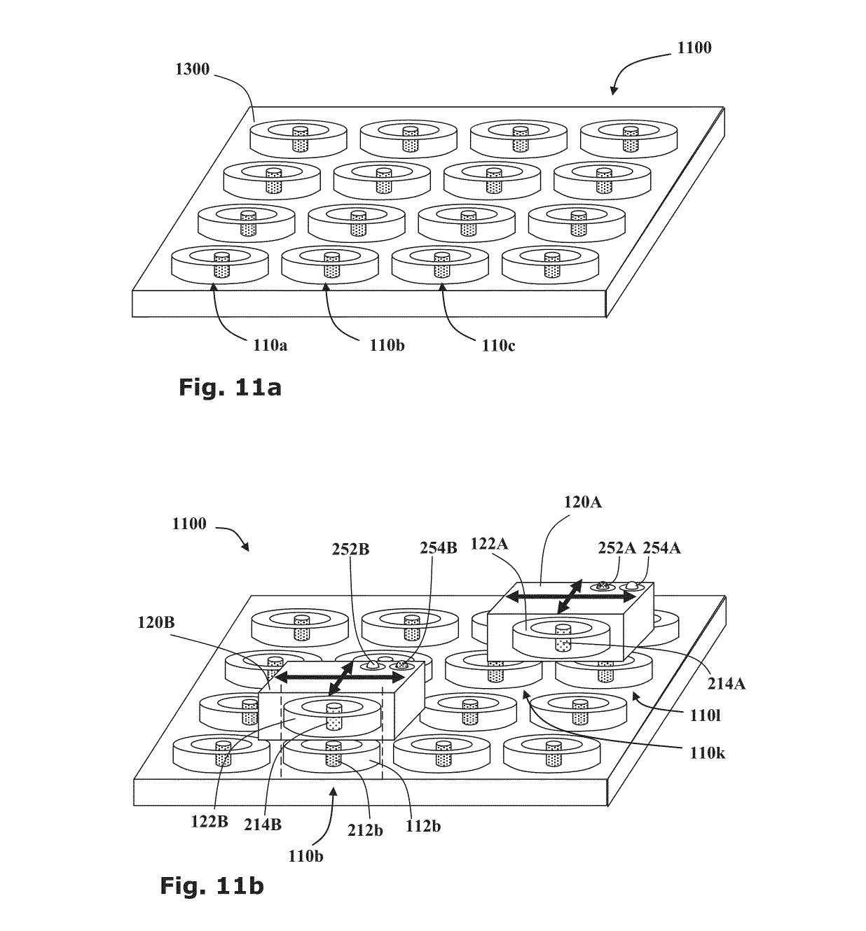

A plurality of pinless power jacks 110a-n are shown in FIG. 11a arranged into a power array 1100 covering an extended surface 1300 according to still a further embodiment of the invention. The power array 1100 allows for a pinless power plug 120 to be aligned with a power jack 110 in a plurality of locations over the surface 1300. It is noted that although a rectangular arrangement is represented in FIG. 11a, other configurations such as a hexagonal close packed arrangement, for example, may be preferred. Optionally multiple layers of overlapping power jacks 110 may be provided. Since a power plug may be placed in alignment with any of the power jacks 110a-n, a power supplying surface may be provided which can provide power to a plug 120 placed at almost any location thereupon, or even to a plug in motion over the power array 1100.

With reference to FIG. 11b, two pinless power plugs 120A, 120B are shown lying upon a single power array 1100 including a plurality of embedded jacks. The plugs 120A, 120B are free to move parallel to the surface 1300 as indicated by the arrows. As a plug 120, moving along the power array 1100, approaches a jack 110, an anchor 214 associated with the 120 couples with a snag 212 associated with a jack 110 so bringing the primary coil 112 into alignment with a secondary coil 122.

When a power plug 120A lies between two jacks 110k, 110l, its anchor 214a is not engaged by any snag 212. Consequently, the secondary coil 122A of the power plug 120A is not aligned with any primary coil 112. In such a situation an orange LED indicator 252A for example, may be used to indicate to the user that the plug 120A is close to but not optimally aligned with a primary coil 112. Where a power plug 120B lies directly in line with power jack 110b such that its anchor 214B is engaged by a snag 212b embedded in the power jack 110b, the secondary coil 122B is optimally aligned to the primary coil 112b of the jack 110b and this may be indicated for example by a green LED indicator 254B.

Reference is now made to FIG. 11c showing a power plug 1200 provided with multiple secondary coils 1202a, 1202b according to another embodiment of the invention. Efficient inductive power transfer may occur when either one of the power plug's secondary coils 1202 is aligned to any primary coil 112. It is noted that known multicoiled power plugs such as the double coiled plug described in U.S. Pat. No. 6,803,744, to Sabo, need to be specifically and non-rotatably aligned such that the two secondary coils are both coupled to primary coils simultaneously. In contradistinction to the prior art, in the multicoiled power plug 1200 of the present embodiment of the invention, only one secondary coil 1202 aligns with one primary coil 110 at a time. Alignment may thereby be achieved at any angle and the multicoiled power plug 1200 may be rotated through 360 degrees or more about the axis X of the primary coil 110.

Furthermore, in the multicoiled power plug 1200, the distance between the secondary coils 1202 may advantageously be selected to differ from the inter-coil spacing of the power platform array 1100. The multicoil power plug 1200 may then be moved laterally over the power surface 1100 and the driving unit of the power array 1100 may activate the primary coils located closest to the multicoil power plug 1200. As the multicoil power plug 1200 is moved laterally, the secondary coils 1202a, 1202b both receive power from the primary coils in their vicinity. The power transferred to both the secondary coils 1202a, 1202b undergoes diode summation to produce a total voltage output. Because the two secondary coils 1202a, 1202b are never both aligned simultaneously, the total output voltage is smoothed and power fluctuations normally associated with power transfer to moving power plugs may be prevented. This increases overall efficiency and reduces the need for large variations in the power provided to the power array 1100.

Inductive power transfer models have been simulated to measure the efficiency of power transfer to multiple secondary coils from a power surface with inter coil separation of 8.8 cm. With voltage applied only to the primary coil closest to a pair of secondary coils separated by 4.4 cm (half the surface intercoil separation), the efficiency of total energy transferred to the pair of secondary coils does not fall below 80% as the pair of secondary coils undergoes lateral translation along the surface. This efficiency is further improved by increasing the number of secondary coils, for example in simulations of a triplet of secondary coils spaced at 2.9 cm from each other efficiencies of 90% were achieved.

In other embodiments of the invention where a multilayered power surface is provided, each layer of primary coil arrays is offset from the others, for example by half the surface intercoil separation. A single coiled pinless power plug may be placed upon the multilayered power surface and the driving unit of the power surface configured to activate only the primary coils within the multilayered power surface located closest to alignment with the secondary coil of the power plug regardless of its layer. In this way, the voltage, efficiency and power transferred to the receiving coil are greatly stabilized.

Power arrays 1100 may be incorporated within any flat surface 1300 where it is convenient to provide power. Such surfaces include walls, floor areas, ceilings, desktops, workbenches, kitchen work surfaces and counter tops, shelves, doors and door panels and the like.

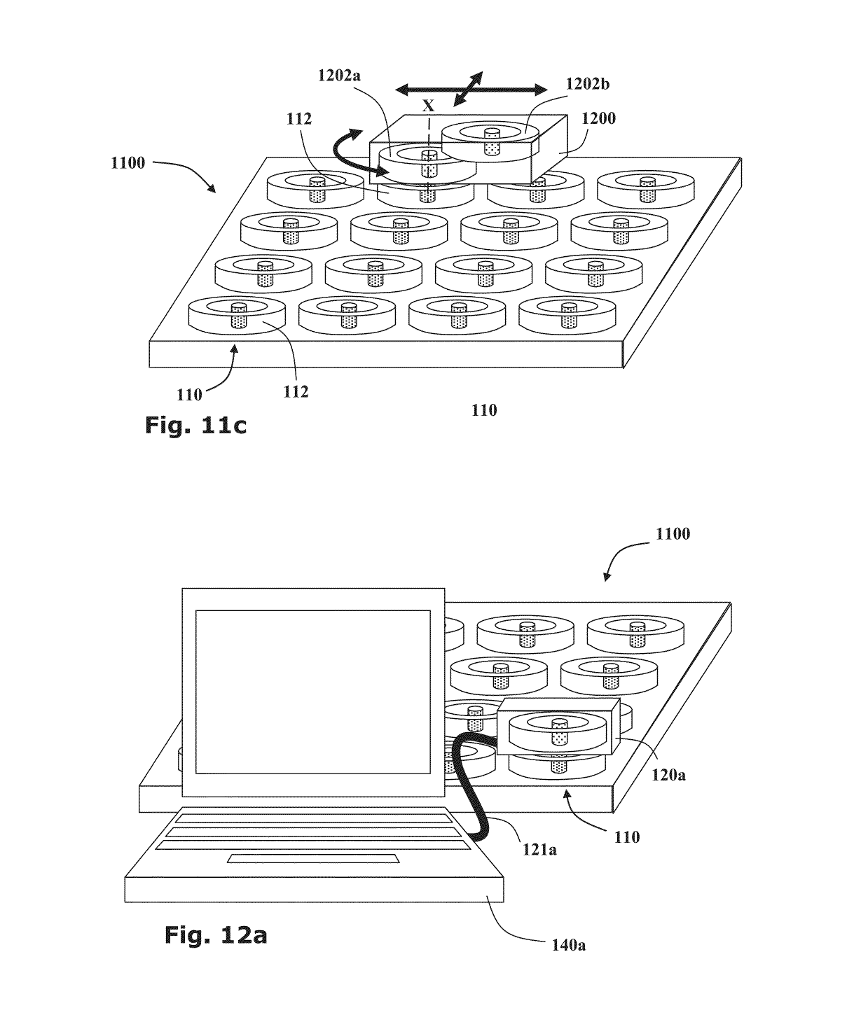

For example, FIG. 12a shows an exemplary horizontal power array 1100 and a pinless power plug 120a electrically coupled to a computer 140a by means of a connecting cable 121a. The pinless power plug 120a is placed upon the power array 1100 and is inductively coupled to a pinless power jack 110 therewithin. Power supplied to the computer 140a may power the computer 140a directly and/or recharge a rechargeable power cell thereof. The arrangement of FIG. 12a with pinless power plugs 120a connected by cables 121a, typically reduces the length and number of wires and cables 121a necessary when connecting a computer 140a to a power source, and thus may be beneficial in conference rooms and the like, where such wires are obstructing, unsightly and generally inconvenient. It is noted that the pinless power plug 120a may alternatively be integral to the computer 140a, and the connecting cable 121a thereby dispensed with altogether.

FIG. 12b shows an exemplary power array 1100 that is inverted and horizontal for fixing to a ceiling, for example. Two pinless lighting plugs 120b carrying light sockets 121b for accommodating light bulbs 140b are shown. The lighting plugs 120b are movable and may be coupled to any one of the plurality of pinless power jacks 110 of the power array 1100. In a preferred embodiment, strong magnetic anchors 214 carried by the lighting plugs 120a exert a force upon the magnetic snags 212 embedded in the power array 1100 of sufficient strength to support the weight of the lighting plugs 120a. In this way, pinless lighting plugs 120a may be easily moved and reattached at different locations around the power array 1100.

It will be noted that the power array 1100 shown in FIG. 12b is inverted, allowing lighting plugs 120b to be suspended therebeneath. For many lighting applications, such as for the lighting of a room, such an arrangement is preferred as overhead lighting is less likely to be obscured by objects than lower level lighting. However a lighting power surface may be hung vertically or embedded into a wall, or indeed placed underfoot or in any other orientation.

It is noted that domestic incandescent light bulbs generally require power in the range of 10-150 W, it is thus desirable for a lighting plug 120b to supply electricity at this power. The inductive transmission of energy in this power range is enabled by the efficient alignment of highly efficient coils such as that shown in the configuration of FIGS. 3a and 3b described herein. Low power lights such as fluorescent bulbs, LEDs and the like, typically use lower power plugs.

With reference to FIG. 12c, an exemplary vertical power array 1100c is shown which may for example be incorporated into the wall of a room, mounted onto the side of a cabinet or other vertical surface. The power array 1100c is used for providing moveable power outlets 120d into which a pinned plug connected to a power cable (not shown) may be plugged, for coupling an electric load to an inductive power jack 110 and thereby providing power to the electric load.

Two movable power outlets 120d are also shown. Each outlet 120d includes a magnetic anchor 214 which may be of sufficient strength to support the weight of the movable power outlet 120d when coupled to a magnetic snag 212 embedded in the vertical power array 1100c. Such power outlets 120d may thus be freely moved around the vertical power array 1100c and located at any position which is aligned to a pinless power jack 110. (Although a vertical power array 1100c is shown in FIG. 12c, it will be apparent that movable power outlets 120d may be coupled to a power array 1100 with any orientation).

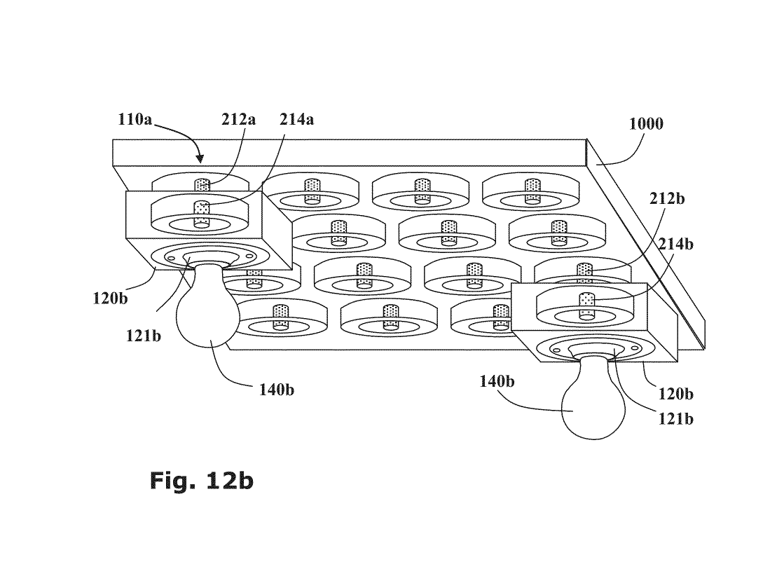

FIG. 13 is a flowchart showing a method for transferring an optical signal between a primary unit and a secondary unit via an intermediate layer. The method comprises the following steps: an optical transmitter is incorporated within the secondary unit—step (a); an optical receiver is incorporated within the primary unit—step (b); the optical transmitter transmits electromagnetic radiation of a type and intensity capable of penetrating the surface layer—step (c); and the optical receiver receives the electromagnetic radiation—step (d).

It will be appreciated that such a method may be applicable to transmitting a regulation signal for regulating power transfer across an inductive coupling by monitoring at least one operating parameter of said electric load and encoding the monitored parameter data into said optical signal. Similarly, data relating to the presence of an electric load, its power requirements, operating voltage, operating current, operating temperature or the like may be communicated.

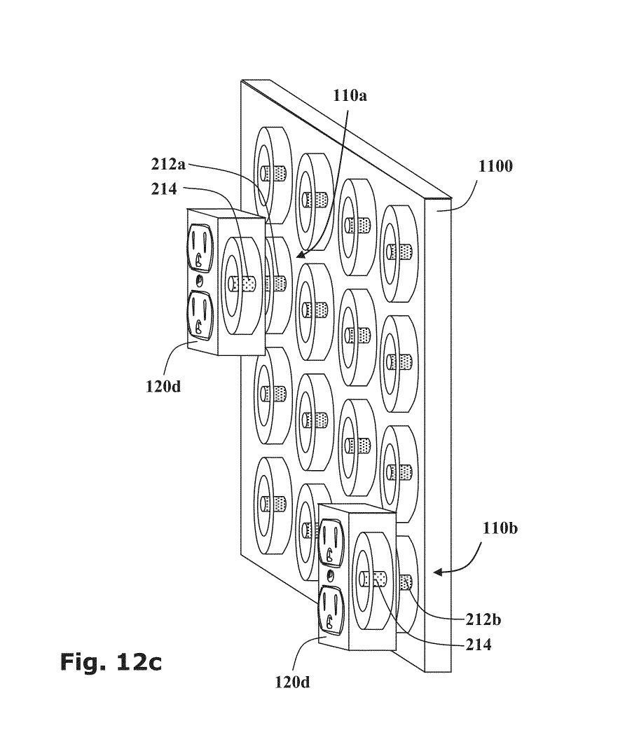

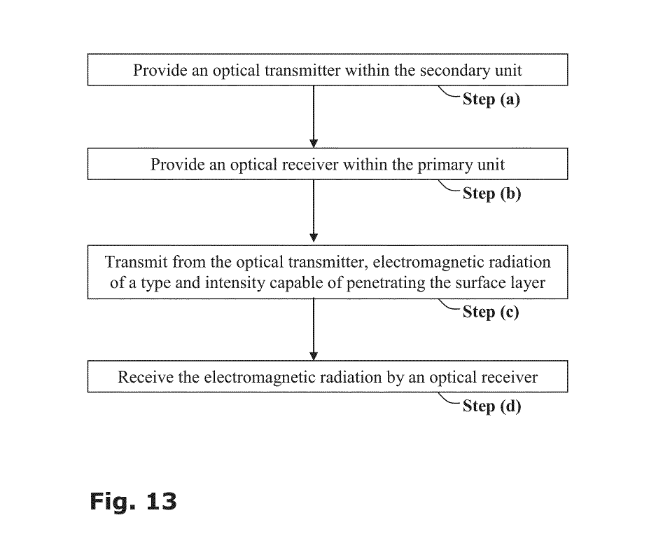

As illustrated in FIG. 14, there is provided a wireless power outlet 410, such as an inductive power outlet, a resonant power outlet, or the like, constituting an inductive transmitter adapted to transmit electrical power wirelessly to a secondary unit (such as a wireless power receiver, e.g., an inductive receiver; not illustrated) remote therefrom. The wireless power outlet 410 comprises a primary inductive coil 412 connected to a resonant circuit 414 constituting a power source and comprising, inter alia, a driver 416. The driver 416 is configured to provide an oscillating driving voltage to the primary inductive coil 412. The wireless power outlet 410 may further comprise a controller 418, such as a microcontroller unit, to direct operation thereof. For example, the controller 418 may be configured to implement the different phases described below. The wireless power outlet 410 may be designed to operate in any suitable range, for example about 100 kHz to about 500 kHz.

The wireless power outlet 410 as described herein may be configured to communicate with a suitable receiver. Such a receiver may, inter alia, be configured to transmit signals to the wireless power outlet 410, which the wireless power outlet is configured to decode and take suitable actions based thereon. For example, the receiver may be configured to transmit some or all of the following:

Inc signals, indicating that the frequency of power transfer should be incremented;

Dec signals, indicating that the frequency of power transfer should be decremented;

No-ch signals, indicating that power transfer should not be changed;

EOP signals, indicating that the power transfer should be ended; and

other signals indicating receiver status, receiver information, etc.

It will be appreciated that the above is a partial list, and the receiver may be configured to transmit any other suitable signal per the requirements of a designer or suitable specification.

According to one example, as illustrated in FIG. 2, the primary inductive coil 412 comprises two windings 420, arranged one atop another as layers. Each of the windings 420 comprises a single low-resistance wire 422 which is coiled, forming a substantially circular shape and giving rise to an internal space 424 therewithin. The wire 422 may be formed having nine turns, or any suitable number of turns. The primary inductive coil 412 (i.e., the windings 420) has an outer diameter D1 and an inner diameter (i.e., the diameter of the space 424) D2. The outer diameter may be as per need, for example no less than 53.5 mm. The inner diameter may be as small as possible, e.g., between 20 and 21 mm, for example about 20.5 mm.

The wire 422 may comprise a plurality of thin wire strands, individually insulated and twisted and/or woven together. The strands may be organized in several levels, e.g., groups of twisted wires twisted together. According to some modifications, the wire 422 may be a litz wire, e.g., having a low AC-resistance (i.e., impedance). The litz wire may be provided according to any suitable design, many of which are known in the art and available in a wide variety of configurations.

According to some modifications, the litz wire comprises between 165 and 175 strands, e.g., 170 strands. It has been found that a litz wire with this number of strands has an advantage over other designs of litz wires, in that it results in an optimal quality-factor compared to using other tested litz wires. Increasing the number of strands in a multi-strand wire, such as litz wire, tends to lower the resistance (and thus increasing quality-factor), while increasing the minimum inner diameter possible when forming a winding 420, as well as proximity effects, e.g., owing to parasitic capacitance (both of which tend to increase the quality-factor). It has been found that a litz wire of 170 strands, or approximately thereof, optimizes the quality-factor when all other design considerations of the wireless power outlet remain the same.

According to other medications, the diameter of each of the strands of the litz wire is no more than twice the skin depth associated with its conductive material. This maximizes the amount of material of the strands which conduct the current through the primary inductive coil 412. One having ordinary skill in the art may be determine the skin depth for a material

given the intended AC current and frequency of the wireless power outlet 410. For example, it may be approximated by:

δ=[2ρ/(ω·μᵣ·μ₀)]^{1/2}

where:

δ is the skin depth;

ρ is the resistivity of the material;

ω is the angular frequency of the current (i.e., 2π times the frequency);

μᵣ is the relative magnetic permeability of the conductor; and

μ₀ is the permeability of free space.

According to some modifications, the primary inductive coil 412 may comprise a single winding 420, e.g., to reduce parasitic capacitance which may arise. In order to provide such a primary inductive coil, care must be taken that winding 420 is designed so as to provide an appropriate inductance.

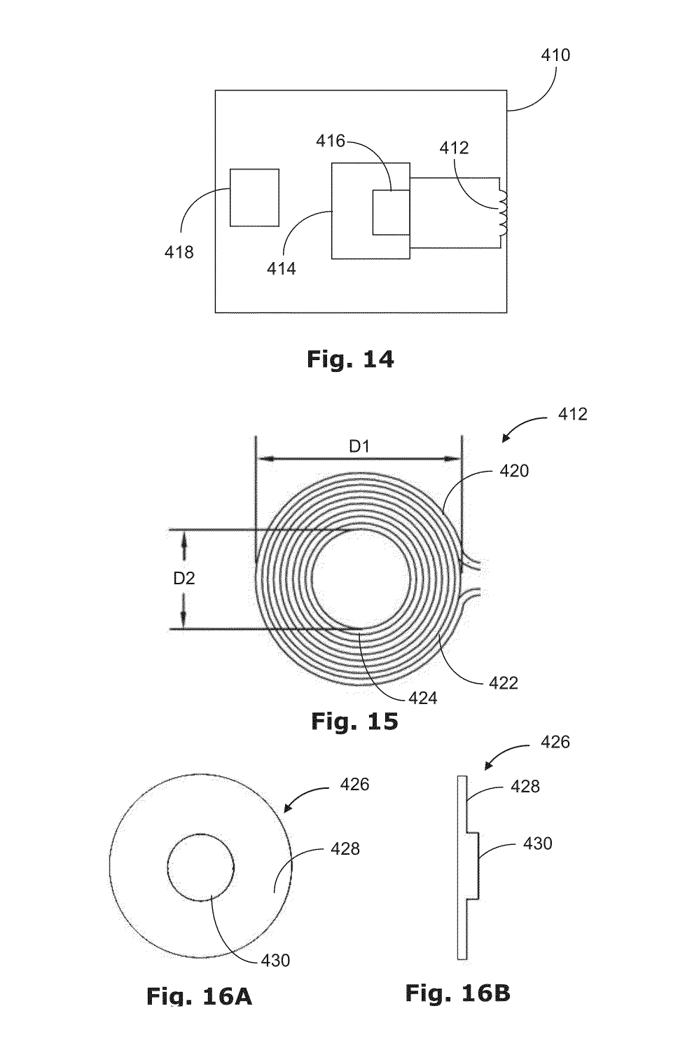

As illustrated in FIGS. 16A and 16B, the wireless power outlet 410 may further comprise a shielding 426 below the primary inductive coil 412. The shielding 426 comprises a base 428, which may be substantially circular, and a core 430 (so called as it constitutes of metallic core of the windings 420) protruding upwardly therefrom. It may be made of any suitable material for the frequency range in which the wireless power outlet 410 operates, such as a metal. According to some modifications, it is made from a ferrite material, such as magnesium ferrite. According to other modifications, for example at relatively higher frequencies, the material of the shielding 426 may be nickel.

The diameter of the base 428 may be at least 10% greater than the outer diameter of the windings 16. According to some modifications, the diameter of the base 428 is at least about twice the outer diameter of the windings. The diameter of the core 430 is suitable to fit within, e.g., be snuggly received within, the space 424 formed within the windings 420, and may be, e.g., 20 mm. The overall thickness of the shielding 426 (i.e., the thickness of the base 428 and core 430 together) may be about 6 mm.

The windings 420 are disposed such that the core 428 of the shielding 426 is received within the space 424 therewithin. This provides a better magnetic conductance compared to what would be provided if the space 424 was filled with air. Furthermore, it may provide a magnetic snag, facilitating alignment of a receiver.

Depending, e.g., on an intended power level and thermal management strategy, the wireless power outlet 410 may comprise an optional metal carrier (not illustrated) below the shielding 426 (i.e., on the side thereof opposite the windings 420). The metal carrier may be provided according to any suitable design, as is well known in the art.

The windings 420, shielding 426, and optional carrier may be co-disposed such that central axes thereof are coincident with one another.

It has been found that a wireless power outlet 410 designed as per the above has an increase quality-factor compared to other designs. For example, a quality-factor of about 140 may be realized. The increased quality-factor increases the optimal magnetic efficiency of the wireless power outlet 410, even when a couple having a low coupling factor is formed with a suitable receiver, for example which may result from relatively high coil to coil distances.

One having ordinary skill in the art may determine the quality-factor for the wireless power outlet 410 according to any suitable method. For example, it may be given by:

Q=ω₀L/R

where:

Q is the quality-factor;

ω₀ is the resonance frequency in radians per second;

L is the inductance of the primary inductive coil 412; and

R is the resistance of the primary inductive coil.

The driver 416 may operate with an input voltage of between 18.5V and 19.5V. According to some examples, the driver 416 is configured to operate at an input voltage of 18V. The resistance of the driver may be 30 milliohms. According to some examples, it may be up to 150 milliohms. It may be further configured to operate with a default duty cycle of 50%+/−5% in a half-bridge mode. At the high end of the operational range (i.e., the highest frequency at which the wireless power outlet 410 is designed to operate), the duty cycle may vary between 10% and 50%. The driver 416 may be further configured to vary the phase offset between 10% and 100% in a full-bridge mode.

The wireless power outlet 410 may be configured to sense a power carrier voltage signal associated with the primary inductive coil 412, e.g., using a magnitude detector (not illustrated), as is known in the art. In the event that the value of the voltage signal exceeds a predefined level, the wireless power outlet 410 may be configured to stop its power signal and enter a Standby phase, as will be described below.

The wireless power outlet 410 may comprise protection mechanisms, e.g., for over-voltage, over-temperature, over-decrement, and/or over-current occurrences conditions.

The wireless power outlet 410 may be further configured to detect a suitable receiver (not illustrated) placed thereof. Accordingly, it may comprise a detection unit (not illustrated) configured to implement an analog pinging method, e.g., using a periodic short pulse applied to the primary inductive coil 412. By measuring the resultant interference on the primary coil, the presence of a receiver can be detected. The pinging pulse's characteristics may be as follows:

a short pulse comprising a pack of 3 rectangular wave pulses at a frequency of 175±10 kHz with a duty cycle of 10±1%;

the time between sequential packets is 25-250 ms; and

a detection is determined if the voltage difference between the voltage measured on the primary inductive coil 412 measured with and without a suitable receiver present is higher than 2.7V.

The wireless power outlet 410 may be configured to operate in one of a Standby phase, a Digital Ping phase, an Identification phase, a Power Transfer phase, and an End of Power phase. Each of these phases may be as described below.

In the Standby phase, the wireless power outlet 410 monitors a Tx charging surface (i.e., the surface thereof where the receiver is to be placed) thereof to detect a possible receiver placement. The monitoring may be done by using the detection unit as described above.

If the Standby phase is reached due to an error state as described below, the wireless power outlet 410 may be configured to wait for receiver removal before proceeding to monitoring the surface for receiver placement.

If a receiver placement is detected, e.g., by the detection unit, the wireless power outlet 410 may be configured to continue to the Digital Ping phase. The time for the phase change may be between 23 and 250 ms, e.g., 200 ms.

The wireless power outlet 410 may be configured to implement detection of a receiver using an analog ping as described above.

Once a receiver is detected, the wireless power outlet 410 may be configured to enter the Digital Ping phase, in which it engages with a possible receiver and identifies whether or not it is a valid (i.e., compatible) receiver. It accomplishes this by generating a digital ping signal as described below. If sufficient power is delivered to the receiver by the generated digital ping, the receiver will respond by suitably modulating the power signal.

The Digital Ping phase may comprise the following two-stage procedure:

In a first stage, the wireless power outlet 410 is configured to produce digital pings designed to induce a maximal voltage on a reference receiver having an inductance of 4.7 μH and with no load attached thereto, and operating with a coupling factor of 0.4, in the range of 4-6V.

If no response is received from the receiver for at least a predetermined number of consecutive digital pings in the first stage, the wireless power outlet 410, a second stage, is configured to produce digital pings designed to induce a maximal voltage on the reference receiver with no load attached thereto, and operating with a coupling factor of 0.55, in the range of 8-10V.

If the wireless power outlet 410 receives a valid response from the receiver during the Digital Ping phase, it is configured to continue to the Identification phase without removing the power signal.

If an EOP signal is received from the receiver during the Digital Ping phase, the wireless power outlet 410 is configured to continue to the End of Power phase.

If no response was detected during a predetermined period of time, the wireless power outlet 410 is configured to return to the Standby phase.

The wireless power outlet 410 may be configured to advertise its Tx-type during the Digital Ping phase. Advertising of the Tx-type may be performed by frequency modulation of the power carrier signal.

The Digital Ping phase may be delayed for a time period of between 23 and 250 ms, for example 200 ms, after a suitable receiver has been detected (i.e., after the last active analog ping signal).

The Digital Ping phase may be characterized by the following:

The duration of the digital ping may be between 26.0 and 28.0 ms.

In the first part of the digital ping, a frequency sweep from a minimum frequency (which may be between 285 kHz and 315 kHz, for example 300 kHz) is generated. The duration of the frequency sweep is between 1 and 4 ms.

After the frequency sweep, the wireless power outlet 410 advertises its type. The advertising may comprise frequency modulation of the power carrier signal. The modulation may use Manchester coding with a modulation depth between 5 and 10 kHz, and have a symbol length between 475 and 525 μm, for example 500 μm. A 12-bit identification code (8 bits of data & 4 bits of CRC calculation) is transmitted cyclically between 1 and 4 ms after the start of the Digital Ping signal and after the sweep period is over. Transmission of the code is repeated for between 19 and 22 ms. The frequency is not modulated for a period no longer than 1 ms between each of the retransmissions of the identification code. The last retransmission of the identification code may begin after 15 ms, measured from the start of the digital ping.

After the advertising period, the wireless power outlet 410 remains at a frequency of between 220 and 226, for example at 223, for a time period of between 5 and 7 ms. During this time, the wireless power outlet 410 may read data sent from the receiver.

A valid response from the receiver comprises at least a predetermined number, which may be between 5 and 15, of consecutive Dec signals. Any other signal received is interpreted by the wireless power outlet 410 as invalid response. After the reception of the valid data signals from the receiver, the wireless power outlet 410 transitions to the identification phase. If no valid response is received by the wireless power outlet 410 during the first Digital Ping period, the power signal is stopped, and it waits between 30 and 300 ms, for example 150 ms, before starting a subsequent Digital Ping.

The wireless power outlet 410 generates a total of 5 retries of the Digital Pings signals if no valid response is received from the receiver in each of those retries. If no response is received from the receiver during any one of the Digital Pings signals, the wireless power outlet 410 transitions to the Standby phase.

The 8 bits of data of the identification code may be characterized in that the five most significant bits carry a type code (i.e., MSB0-MSB4, wherein MSB4, which is the most significant bit of the type code, and thus of the identification code) is always set to 0), and the three least significant bits thereof carry a capability code.

The two most significant bits of the capability code carry information relating to extended signaling (ES) support, wherein:

0b00 represents standard signaling;

0b01 represents unidirectional ES support;

0b10 represents bidirectional ES support; and

0b11 represents continuous bidirectional ES support.

The least significant bit of the capability code indicates RXID verification.

The 4 bits of data of the CRC calculation are in accordance with the CRC-4 defined in ITU Telecommunication Standardization Sector (ITU-T) standard for synchronous frame structures designated G.704.

In the Identification phase, which begins upon completion of the Digital Ping phase (i.e., when the predetermined number of consecutive Dec signals are received), the wireless power outlet 410 is configured to identify an RXID (i.e., a unique MACID of a receiver) returned by the receiver, and to verify that it is a compliant device. The wireless power outlet 410 may be configured so as to not support an Identification phase, in which case it continues with the Power Transfer Phase.

The Identification phase comprises a Minimal Ping Frequency sub-phase, a Stabilization sub-phase, and an optional RXID retry attempt.

In the Minimal Ping Frequency sub-phase, the wireless power outlet 410 provides a constant power signal with an operational frequency between 220 and 226 kHz, e.g., 223 kHz. The wireless power outlet 410 is configured to determine that the Minimal Ping Frequency sub-phase is completed, and proceed with the Stabilization sub-phase, if one of the following situations occurs:

A time period, measured from the first Dec signal received during the Digital Ping phase, of t_{wait4Rx}=35 ms is exceeded.

A signal other than Dec signal is received from the receiver.

During the stabilization sub-phase, the receiver stabilizes the power it receives from the wireless power outlet 410. The wireless power outlet 410 is configured to adjusts its operational frequency according to the DEC, INC and/or No-ch signals received from the receiver, as described below with reference to the Power Transfer phase.

After the time period t_{wait4Rx} elapses, the wireless power outlet 410 is configured to read the RXID data or adjust its operational frequency according to signals received from the receiver (e.g., as described below with reference to the Power Transfer phase).

The wireless power outlet 410 is configured to receive the RXID preamble byte, followed by the rest of the RXID data sequence, for a predetermined time period of between 230 and 250 ms after the reception of the predetermined number of consecutive signals Dec signals from the receiver.

Upon receipt of the last byte of the RXID message, the wireless power outlet 410 is configured to calculate the CRC during a predetermined amount of time, e.g., 20 ms. If the CRC is valid, the wireless power outlet 410 is configured to transition to the Power Transfer phase.

The wireless power outlet 410 is configured to perform retries of the identification phase if one of the following scenarios occurs:

any of the RXID bytes are missing an ST or SP bit;

the RXID preamble byte is not 0x00;

the message ID byte is not compliant;

during the RXID message transmission, a Data Loss (data timeout) occurrence is detected;

CRC calculation is followed with an invalid CRC result;

the wireless power outlet does not receive the preamble byte during the predetermined time period of between 230 and 250 ms.

If the wireless power outlet 410 begins one or more RXID retry attempts, it removes the power carrier by moving into the Standby phase and waiting for a wait period of at least 250 ms. According to some modifications, the wait period may range between at least 30 ms to at least 300 ms. After the wait period, the wireless power outlet 410 restarts the Digital Ping phase, thereby forcing the receiver to repeat the Identification phase. The wireless power outlet 410 may be configured to attempt five RXID retry attempts. According to some modifications, the wireless power outlet 410 is be configured to attempt one RXID retry attempt.

After exhausting the retries and if not successful, the wireless power outlet 410 is configured to remove the power carrier and wait for receiver removal, and subsequently transition to the Standby phase.

When the receiver is placed in full alignment, the time period from receiver detection (i.e., last Analog Ping) to the beginning of the Power Transfer phase shall be no longer than 1000 ms. When the receiver is placed within a supported misalignment distance (as described below), the transition shall be no longer than 5000 ms.

During the Power Transfer phase, the wireless power outlet 410 is configured to regulate its delivered power by adjusting the operation frequency according to the receiver's requests, e.g., by changing its primary coil current. This is done in response to Dec signals or Inc signals.

If an EOP signal is received from the receiver, or the temperature exceeds a maximum predefined value (as described below), the wireless power outlet 410 is configured to cease the power signal and continue to the End of Power phase.

The wireless power outlet 410 may be configured to perform each adjustment within 50 μs from reception of a valid request from the receiver.

The wireless power outlet 410 may be configured to use a shall use a Fast First-Order Tracking (FFOT) algorithm to control its operational frequency according to feedback provided by the receiver in order to meet the required power input.

The receiver is configured to request an increase, decrease, or no change in the delivered power.

The wireless power outlet 410 is configured to decimate every two Dec signals, such that only one of every two Dec signals creates a change in operation point. Furthermore, it is configured to decimate every five Inc signals, such that only one of every five Inc signals creates a change in operation point. According to some modifications, the wireless power outlet 410 is configured to decimate every six Inc signals, such that only one of every six Inc signals creates a change in operation point

When receiving a Dec signal, the wireless power outlet 410 is configured to decimate every two successive Dec signals, and, after the 2^{nd} signal, to decrease its operation frequency by between 1.4 and 4.0 kHz. This change is only performed if the new operation point is no less than a predefined minimum operation frequency of between 196.0 and 200.0 kHz, for example 198.0 kHz.

When receiving an Inc signal after a non-Inc signal, the wireless power outlet 410 is configured to increase its operation frequency. If the Inc signal is followed by additional Inc signals, the wireless power outlet is configured to decimate a predetermined number (which may be five or six) successive Inc signals, and only after receiving the predetermined number of Inc signals to increase its operation frequency by between 1.4 and 4.0 kHz. This change is only performed if the new operation point is no greater than a predefined maximum operation frequency of between 296.0 and 304.0 kHz, for example 200.0 kHz.

The wireless power outlet 410 is configured to maintain its current operation point upon receipt of a No-ch signal (i.e., a signal from the receiver indicating that power transfer should not be changed).

The wireless power outlet 410 may be configured to move to its minimum operational frequency (maximal power transfer) irrespective of its starting frequency upon receipt of 100 consecutive Dec signals.

The wireless power outlet 410 may be configured to move to its maximum operational frequency (minimal power transfer) irrespective of its starting frequency upon receipt of 180 consecutive Inc signals.

The wireless power outlet 410 may be configured to transition to the End of Power phase if it receives an EOP signal from the receiver, in which case it removes the power carrier for a predetermined period of time of between 5 and 280 minutes, e.g., 15 minutes. After the predetermined period of time expires, the wireless power outlet 410 is configured to step into the Digital Ping phase and try to reengage with the receiver.

In addition, the wireless power outlet 410 may be configured to transition to the End of Power phase if the temperature exceeds a predetermined level, as described below. The wireless power outlet 410 is configured in this case to remove the power carrier and monitor its temperature and detection sensors until the measured temperature returns to below the predetermined level, then to proceed to the Digital Ping Phase.

In addition, the wireless power outlet 410 may be configured to transition to the End of Power phase if other predetermined error conditions are detected.

The wireless power outlet 10 may be further configured to proceed to the Standby Phase if the receiver removal occurs during any part of the End of Power phase.

The wireless power outlet 410 may be configured to detect foreign objects placed on its charging surface, for example by using a combination of different sensors.

The wireless power outlet 410 may be configured to measure the primary coil peak voltage during all phases of operation and, if it exceeds a predetermined value, to stop the power signal and wait for receiver removal. It subsequently transitions to the Standby phase. In addition, it may be configured to measure the primary coil current and, if it exceeds a predetermined maximum current value, to stop the power signal and wait for receiver removal, after which it transitions to the Standby phase.

The wireless power outlet 410 may be further configured to implement a backup mechanism of temperature measurement during all phases, according to which the wireless power outlet transitions to the End of Power phase if the temperature exceeds a predetermined value, and wait until the temperature drops to below the predetermined value.

The wireless power outlet 410 may be further configured to receive and decode Consumed Power reports from the receiver and, if a Consumed Power report indicates that the power consumed by the receiver is lower than a predetermined amount, to assume that a foreign object has been placed on its charging surface. It may then stop the power signal and wait for receiver removal, after which it transitions to the Standby phase.

The wireless power outlet 410 may determine that a Data-Loss condition has occurred when fewer than five sequences of at least two legal signals are received during a time period of 300 ms.

The wireless power outlet 410 may determine that an Over-Decrement condition occurs when it receives more than a predetermined number (e.g., between 500 and 1000) of Dec signals from the receiver, while it operates in its maximal energy transfer operational point. This may occur, e.g., when the wireless power outlet 410 cannot provide sufficient power to the receiver during the Identification Phase or during the Power Transfer Phase, possibly due to a coil to coil misalignment or mismatch in the power requirements of the receiver and inductive power outlet.

The wireless power outlet 410 may be configured to transit to the End of Power phase when an Over-Temperature condition of over 60° C. is detected on a charging surface thereof.

The wireless power outlet 410 may be configured to transition to the Standby phase when an error scenario is detected. Error scenarios may include, but are not limited to, any one or more of the following:

no valid data received from the receiver during the Digital Ping phase and all retries procedures have been exhausted;

an Over-Voltage condition occurs;

an Over-Current condition, as described above, occurs;

an Over-Input Voltage condition occurs;

a Data-Loss condition, as described above, occurs;

an Over-decrement condition, as described above, occurs; and

an invalid receiver ID (RXID) is received.

According to some examples, the wireless power outlet 410 may be configured to generate a retry procedure if a Data Loss condition is detected during the Power Transfer phase. The retry procedure may comprise the wireless power outlet 410 stopping the power signal for a period between 30 and 300 ms, e.g., 150 ms, and then restarting the Digital Ping phase. The retry procedure is done once for each occurrence of a Data Loss condition, and may be limited in number (e.g., five occurrences of a Data Loss condition per receiver placement session, i.e., between receiver placement and receiver removal). If the wireless power outlet 410 detects a the removal of the receiver, it may transition to the Standby phase and not restart the Digital Ping. The wireless power outlet 410 is configured to stop the power signal and wait for receiver removal, and then subsequently transition to the Standby phase, if the occurrence of a Data Loss condition continues after the retry procedure and the receiver is still placed on the wireless power outlet.

The wireless power outlet 410 may be configured such that power consumption thereof while no receiver is placed thereon, averaged across the periods of standby and analog ping bursts, does not exceed 1 W.

It may be further configured such that the average power consumption thereof while a receiver is placed thereon, but is not actively supplying power thereto shall not exceed:

1 W−[(2 W×Carrier_Active_Time)/hour]

where Carrier_Active_Time is the active time of the power carrier during a one hour period (summation of the digital ping periods until reception of an EOP signal and power carrier removal).

The wireless power outlet 410 may be configured to ensure that, during the full charge cycle, it will continually indicate to the user ongoing charging and any removal of the receiver.

The wireless power outlet 410 may be configured so as to not generate any audible noise exceeding 30 dB SPL when measured at a distance of 1 m therefrom.

The wireless power outlet 410 may be configured so as to not interfere with the operation of the device powered thereby.

The wireless power outlet 410 may be configured to support a minimum power delivery from the primary inductive coil 412 of 8.5 W for Power Classes from 0-5 W.

The wireless power outlet 410 may be configured to support operation (i.e., charging) of a reference receiver when placed on top thereof with minimum misalignments.

According to some examples, the wireless power outlet 410 supports a misalignment wherein the following conditions are met:

the distance between the primary inductive coil 412 and the Tx charging surface of the wireless power outlet is up to 4 mm;

a gap between the Tx charging surface and the receiver is up to 3 mm;

the receiver has a spacer of up to 0.8 mm between a secondary inductive coil there and an Rx charging surface (i.e., the surface thereof which is placed on the Tx charging surface); and

the distance, measured in a plane parallel to the charging surface, between the centers of the primary inductive coil 412 and of the secondary inductive coil is up to 6 mm.

According to other examples, for example wherein a receiver is specifically designed to operate with the wireless power outlet 410 (sometimes called an “enhanced receiver”), the wireless power outlet supports a misalignment wherein the following conditions are met:

the distance between the primary inductive coil 412 and the Tx charging surface of the wireless power outlet is up to 4 mm;

a gap between the Tx charging surface and the receiver is up to 7 mm;

the receiver has a spacer of up to 0.8 mm between the secondary inductive coil and the Rx charging surface; and

the distance, measured in a plane parallel to the charging surface, between the centers of the primary inductive coil 412 and of the secondary inductive coil is up to 12 mm.

It will be appreciated that the above represent minimum requirements. According to either of the above examples, the wireless power outlet 410 may support operation of a reference receiver when any one or more of the distances is greater than that listed above.

The wireless power outlet 410 may be configured to transmit a TACR (transmitter advanced capabilities reporting) message to indicate its extended capabilities. The capabilities field may include, e.g., values indicating one or more of the power levels supported, extended range support, extended signaling support, WPTN (wireless power transfer network) support, and multimode support.

The wireless power outlet 410 may be configured to support extended power operation for Power Class 0 and up to Power Class 5 power levels. It may be configured, e.g., when operating at the Class 5 power levels, to from using a half bridge topology to a full bridge topology for its power carrier driver.

Those skilled in the art to which this invention pertains will readily appreciate that numerous changes, variations and modifications can be made without departing from the scope of the invention mutatis mutandis.

Technical and scientific terms used herein should have the same meaning as commonly understood by one of ordinary skill in the art to which the disclosure pertains. Nevertheless, it is expected that during the life of a patent maturing from this application many relevant systems and methods will be developed. Accordingly, the scope of the terms such as computing unit, network, display, memory, server and the like are intended to include all such new technologies a priori.

The terms “comprises”, “comprising”, “includes”, “including”, “having” and their conjugates mean “including but not limited to” and indicate that the components listed are included, but not generally to the exclusion of other components. Such terms encompass the terms “consisting of” and “consisting essentially of”.

The phrase “consisting essentially of” means that the composition or method may include additional ingredients and/or steps, but only if the additional ingredients and/or steps do not materially alter the basic and novel characteristics of the composition or method.

As used herein, the singular form “a”, “an” and “the” may include plural references unless the context clearly dictates otherwise. For example, the term “a compound” or “at least one compound” may include a plurality of compounds, including mixtures thereof.

The word “optionally” is used herein to mean “is provided in some embodiments and not provided in other embodiments”. Any particular embodiment of the disclosure may include a plurality of “optional” features unless such features conflict.

Whenever a numerical range is indicated herein, it is meant to include any cited numeral (fractional or integral) within the indicated range. The phrases “ranging/ranges between” a first indicate number and a second indicate number and “ranging/ranges from” a first indicate number “to” a second indicate number are used herein interchangeably and are meant to include the first and second indicated numbers and all the fractional and integral numerals therebetween. It should be understood, therefore, that the description in range format is merely for convenience and brevity and should not be construed as an inflexible limitation on the scope of the disclosure. Accordingly, the description of a range should be considered to have specifically disclosed all the possible subranges as well as individual numerical values within that range. For example, description of a range such as from 1 to 6 should be considered to have specifically disclosed subranges such as from 1 to 3, from 1 to 4, from 1 to 5, from 2 to 4, from 2 to 6, from 3 to 6 etc., as well as individual numbers within that range, for example, 1, 2, 3, 4, 5, and 6 as well as non-integral intermediate values. This applies regardless of the breadth of the range.

It is appreciated that certain features of the disclosure, which are, for clarity, described in the context of separate embodiments, may also be provided in combination in a single embodiment. Conversely, various features of the disclosure, which are, for brevity, described in the context of a single embodiment, may also be provided separately or in any suitable subcombination or as suitable in any other described embodiment of the disclosure. Certain features described in the context of various embodiments are not to be considered essential features of those embodiments, unless the embodiment is inoperative without those elements.

Although the disclosure has been described in conjunction with specific embodiments thereof, it is evident that many alternatives, modifications and variations will be apparent to those skilled in the art. Accordingly, it is intended to embrace all such alternatives, modifications and variations that fall within the spirit and broad scope of the disclosure.

All publications, patents and patent applications mentioned in this specification are herein incorporated in their entirety by reference into the specification, to the same extent as if each individual publication, patent or patent application was specifically and individually indicated to be incorporated herein by reference. In addition, citation or identification of any reference in this application shall not be construed as an admission that such reference is available as prior art to the present disclosure. To the extent that section headings are used, they should not be construed as necessarily limiting.

What is claimed is:

1. A wireless power outlet configured to transmit power to a wireless power receiver, the wireless power outlet comprising:
a metal shielding comprising a substantially circular base and a core protruding therefrom;
a primary inductive coil constituted by two substantially circular windings one atop the other and giving rise to an internal space, said core being received within the space; and
a power source comprising a driver configured to provide an oscillating driving voltage to said primary inductive coil;
wherein:
said base has a diameter which is at least about 10% larger than an outer diameter of said windings;
said circular windings comprise a wire having between 165 and 175 thin wire strands; and
said space has a diameter between 20 and 21 mm.

2. The wireless power outlet according to claim 1, wherein said wire is litz wire.

3. The wireless power outlet according to claim 2, wherein said wire consists of 170 strands.

4. The wireless power outlet according to claim 2, wherein the diameter of each of said strands is no more than twice the skin depth of the conductive material of the wire, at an operating AC current and frequency of the wireless power outlet.

5. The wireless power outlet according to claim 1, wherein each of said windings is formed having nine turns.

6. The wireless power outlet according to claim 1, wherein said shielding is made from a material selected from magnesium ferrite and nickel.

7. The wireless power outlet according to claim 1, wherein said core is substantially circular and is configured to be snuggly received within said space.

8. The wireless power outlet according to claim 1, wherein said core is substantially circular and has a diameter of about 20 mm.

9. The wireless power outlet according to claim 1, wherein said base has a thickness of about 2.75 mm.

10. The wireless power outlet according to claim 9, wherein said shielding has a thickness of about 6 mm.

11. The wireless power outlet according to claim 1, having a quality-factor of at least about 140.

12. The wireless power outlet according to claim 1, configured to operate in a range between about 100 kHZ and about 500 kHz.

13. The wireless power outlet according to claim 1, further comprising a controller configured to direct operation thereof.
